(19) United States
(12) Patent Application Publication
(10) Pub. No.: US 2026/0355667 A1
(43) Pub. Date: Nov. 12, 2026

(54) AIR FILTER

(71) Applicant: Walk Industrial, Inc., Temecula, CA (US)

(72) Inventors: Mitch Walk, Temecula, CA (US); Tyler Walk, Mattoon, IL (US)

(21) Appl. No.: 19/673,797

(22) Filed: May 11, 2026

Related U.S. Application Data
(60) Provisional application No. 63/802,944, filed on May 9, 2025.

(51) Int. Cl. B01D 46/12; B01D 46/52; B05B 14/43

(52) U.S. Cl. CPC B01D 46/12; B01D 46/521; B05B 14/43; B01D 2279/50

(57) ABSTRACT

Embodiments of a filter assembly are disclosed. The filter assembly includes a filter body comprising filter media. The filter body has a front face with a slit formation. A flap defined by the slit-formation extends from an edge of the front face. The flap is configured to bend or deflect inward into a slit formation of the filter body when subjected to airflow.

### CROSS-REFERENCE TO RELATED APPLICATIONS

This application claims the benefit of U.S. Provisional Application No. 63/802,944, filed May 9, 2025, the entire contents of which are incorporated herein by reference.

### FIELD

The present disclosure relates to air filters for use in systems requiring removal of particulates from air flow within the system.

### BACKGROUND

The following description includes information that may be useful in understanding the present disclosure. It is not an admission that any of the information provided herein is prior art or relevant to the presently claimed subject matter, or that any publication specifically or implicitly referenced is prior art.

Various designs and modifications have been introduced to improve the efficiency of air filters. Pleated filter media have been widely adopted to increase surface area and extend the operational life of the filter. Additionally, multi-layered filter systems have been developed to capture larger particles in the initial layers while allowing finer particulates to be trapped in subsequent layers. However, despite these advancements, conventional filter designs are often limited in their ability to optimize airflow while maximizing particulate collection.

Air filters may be used in systems from HVAC units to spray booths. In the case of spray booths, filters are commonly used in environments where air filtration is essential to maintain a clean and safe workspace, such as automotive painting, industrial coating applications, and other spray-based processes. These filters are designed to capture airborne particulates, overspray, and other contaminants generated during these operations. Effective filtration is critical not only for ensuring a high-quality finish but also for maintaining regulatory compliance by reducing the release of harmful substances into the environment.

Conventional spray booth filters generally consist of a fibrous or other filter medium enclosed within a frame. These filters operate by allowing air to pass through the medium, which captures and retains particles based on their size and density. Over time, however, as particulate matter accumulates, the efficiency of the filter decreases, resulting in restricted airflow and reduced filtration performance. This necessitates frequent replacement or cleaning of the filter, leading to increased maintenance costs and operational downtime.

Another challenge arises in environments where air filters encounter fluctuating airflow patterns and varying particulate loads. In such conditions, existing filter designs may fail to adapt effectively, leading to uneven particle accumulation and reduced performance. This not only impacts the quality of the end product but also increases the risk of contamination and equipment malfunction.

In many cases, traditional filters lack the versatility to effectively manage diverse airflows and particulate loads while maintaining consistent filtration efficiency. As a result, there is an ongoing need for improved filter assemblies that can enhance particulate collection, extend the lifespan of the filter, and ensure optimal airflow control without frequent maintenance or replacement. This need may be desired numerous systems requiring air flow, from HVAC units to spray booths.

### SUMMARY

This summary is provided to introduce concepts related to air filtration systems, and more particularly, to air filters configured enhance particulate collection and optimize airflow dynamics. The concepts are further described below in the detailed description. This summary is not intended to identify key features or essential features of the claimed subject matter, nor is it intended to be used to limit the scope of the claimed subject matter.

The present disclosure provides an improved spray booth filter assembly designed to enhance particulate collection and optimize airflow dynamics. The disclosed filter assembly includes a filter body with a front face that defines a slit formation and one or more flaps extending from the edges of the front face into the slit formation. These flaps provide additional surface areas for particulate capture by creating multiple zones where debris can accumulate, including the top surface, the flap surfaces, the sidewalls, and the back wall of the slit formation.

According to an embodiment of the present disclosure, a filter assembly is provided. The filter assembly includes a filter body comprising filter media. The filter body has a front face. A slit formation is formed in the front face of the filter body. A flap extends from an edge of the front face toward the slit formation. The flap is configured to bend or deflect inward into the slit formation when subjected to airflow.

According to another embodiment of the present disclosure, a residential HVAC system is provided. The residential HVAC system includes a housing. A blower is disposed within the housing. A filter assembly is positioned within the housing. The filter assembly includes a first media layer configured with successive peaks and valleys. A second media layer is positioned adjacent to the first media layer, wherein the peaks of the first media layer are connected to the second media layer. A plurality of slit formations are formed in the first media layer, each slit formation of the plurality of slit formations passing through the first media layer.

According to another embodiment of the present disclosure, a reusable filter assembly is provided. The reusable filter assembly includes a frame body defining an interior space. A door is hingedly connected to the frame body. The door is movable between an open position and a closed position. A porous face on the frame body is configured to permit airflow therethrough. A porous face on the door is configured to permit airflow therethrough. A filter element is removably positioned within the interior space. The filter element is configured to capture particulates from air passing through the interior space.

In one embodiment, the filter assembly includes a single flap extending from the top edge of the slit formation, allowing particulates to adhere to multiple surfaces as airflow is directed through the filter. In another embodiment, multiple flaps extend from different edges of the slit formation, creating a more complex filtration path that improves particle capture while maintaining consistent airflow. The shape and positioning of the flaps can be adjusted to control the direction and velocity of airflow, thereby preventing uneven particle accumulation and improving the overall filtration efficiency.

Further embodiments include variations in the slit formation shapes and flap configurations to accommodate different operating conditions and particulate loads. For example, the slit formation may take the form of various geometric shapes such as plus, X, or star shapes, while the flaps may have rounded or angular edges to influence airflow patterns effectively. In addition, the filter assembly may include a pleated filter medium with double pleats and multiple slit formations between successive peaks and valleys, which enhances the overall filtration surface area.

The disclosed filter assembly is versatile and adaptable to different applications, making it suitable for various spray booth environments where consistent filtration performance is essential. The innovative design of the flaps and slit formations not only increases the lifespan of the filter by distributing particulate loads more evenly but also reduces the need for frequent maintenance or replacement.

By incorporating multiple surface areas and strategically positioned flaps, the disclosed filter assembly addresses the limitations of traditional spray booth filters, providing a more efficient and cost-effective solution for maintaining air quality and protecting equipment in industrial environments.

Other and further aspects and features of the disclosure will be evident from reading the following detailed description of the embodiments, which are intended to illustrate, not limit, the present disclosure.

### BRIEF DESCRIPTION OF DRAWINGS

The illustrated embodiments of the subject matter will be best understood by reference to the drawings, wherein like parts are designated by like numerals throughout. The following description is intended only by way of example and simply illustrates certain selected embodiments of devices and methods that are consistent with the subject matter as claimed herein, wherein:

FIG. 1 shows a perspective view of a filter assembly in accordance with a first embodiment, including a filter body, a slit formation formed in the front face, and a flap extending from the top edge of the slit formation;

FIG. 2 shows a front view of the filter assembly in accordance with the first embodiment;

FIG. 3 shows a side view of the filter assembly in accordance with the first embodiment;

FIG. 4 shows a perspective view of a filter assembly in accordance with a second embodiment, where the slit formation is formed between a first flap extending from the top edge and a second flap extending from the bottom edge;

FIG. 5 shows a front view of the filter assembly in accordance with the second embodiment;

FIG. 6 shows a side view of the filter assembly in accordance with the second embodiment;

FIG. 7 shows a perspective view of a filter assembly in accordance with a third embodiment, where a first flap extends from a first side edge and a second flap extends from a second side edge, forming a slit formation in between;

FIG. 8 shows a front view of the filter assembly in accordance with the third embodiment;

FIG. 9 shows a side view of the filter assembly in accordance with the third embodiment;

FIG. 10 shows a perspective view of a filter assembly in accordance with a fourth embodiment, including a slit formation and a flap with a modified shape;

FIG. 11 shows a front view of the filter assembly in accordance with the fourth embodiment;

FIG. 12 shows a side view of the filter assembly in accordance with the fourth embodiment;

FIG. 13 shows a perspective view of a filter assembly in accordance with a fifth embodiment, where the back wall of the filter body is concave, forming a V-shaped slit formation with a flap extending from the top edge;

FIG. 14 shows a front view of the filter assembly in accordance with the fifth embodiment;

FIG. 15 shows a side view of the filter assembly in accordance with the fifth embodiment;

FIG. 16 shows a perspective view of a filter assembly in accordance with a sixth embodiment, where the flap has rounded corners at the ends;

FIG. 17 shows a perspective view of a filter assembly in accordance with a seventh embodiment, where the flap has a semi-circular edge toward the slit formation;

FIG. 18 shows a side view of the filter assemblies in accordance with the sixth and seventh embodiments;

FIG. 19 shows a perspective view of a filter assembly in accordance with an eighth embodiment, where a flap extends over a central slit formation;

FIG. 20 shows a front view of the filter assembly in accordance with the eighth embodiment;

FIG. 21 shows a side view of the filter assembly in accordance with the eighth embodiment;

FIG. 22 shows a perspective view of a filter assembly in accordance with a ninth embodiment, with flaps extending from both the top and bottom edges of the slit formation;

FIG. 23 shows a front view of the filter assembly in accordance with the ninth embodiment;

FIG. 24 shows a side view of the filter assembly in accordance with the ninth embodiment;

FIG. 25 shows a perspective view of a filter assembly in accordance with a tenth embodiment, where a slit formation with a plus-shaped configuration is formed with flaps extending from all edges;

FIG. 26 shows a front view of the filter assembly in accordance with the tenth embodiment;

FIG. 27 shows a side view of the filter assembly in accordance with the tenth embodiment;

FIG. 28 shows a perspective view of a filter assembly in accordance with an eleventh embodiment, where a slit formation with a cross or X shape is formed with flaps extending from all edges;

FIG. 29 shows a front view of the filter assembly in accordance with the eleventh embodiment;

FIG. 30 shows a side view of the filter assembly in accordance with the eleventh embodiment;

FIG. 31 shows a perspective view of a filter assembly in accordance with a twelfth embodiment, where a first media layer with successive peaks and valleys is connected to a second media layer, with each valley including an X-shaped slit formation;

FIG. 32 shows a perspective view of a filter assembly in accordance with a thirteenth embodiment, where a first media layer with successive peaks and valleys is connected to a second media layer, with each valley including a star-shaped slit formation;

FIG. 33 shows a top view of a filter assembly in accordance with the thirteenth embodiment;

FIG. 34 shows an elevation view of a filter assembly in accordance with the thirteenth embodiment;

FIG. 35 shows a perspective view of a filter assembly in accordance with a fourteenth embodiment, where a first media layer with successive peaks and valleys is connected to a second media layer, with each valley including X-shaped slit formations;

FIG. 36 shows a perspective view of a filter assembly in accordance with a fifteenth embodiment, where a first media layer with successive peaks and valleys is connected to a second media layer, with each valley including bowtie-shaped slit formations;

FIG. 37 shows a top view of a filter assembly in accordance with the fifteenth embodiment;

FIG. 38 shows an elevation view of a filter assembly in accordance with the fifteenth embodiment;

FIG. 39 shows a perspective view of a filter assembly in accordance with a sixteenth embodiment, where a first media layer with successive peaks and valleys is connected to a second media layer, with each valley including arrow-shaped slit formations;

FIG. 40 shows a perspective view of a filter assembly in accordance with a seventeenth embodiment, where a first media layer with successive peaks and valleys is connected to a second media layer, with each valley including hexagonal shaped slit formations;

FIG. 41 shows a top view of a filter assembly in accordance with the seventeenth embodiment;

FIG. 42 shows an elevation view of a filter assembly in accordance with the seventeenth embodiment;

FIG. 43 shows a perspective view of a filter assembly in accordance with an eighteenth embodiment, where a first media layer with successive peaks and valleys is connected to a second media layer, with each valley including line-shaped slit formations;

FIG. 44 shows a perspective view of a filter assembly in accordance with a nineteenth embodiment, where a first media layer with successive peaks and valleys is connected to a second media layer, with each valley including heart-shaped slit formations;

FIG. 45 shows a top view of a filter assembly in accordance with the nineteenth embodiment;

FIG. 46 shows an elevation view of a filter assembly in accordance with the nineteenth embodiment;

FIG. 47 shows a perspective view of a filter assembly in accordance with a twentieth embodiment, where a first media layer with successive peaks and valleys is connected to a second media layer, with each valley including a rhombus-shaped slit formation;

FIG. 48 shows a top view of a filter assembly in accordance with the twentieth embodiment;

FIG. 49 shows an elevation view of a filter assembly in accordance with the twentieth embodiment;

FIG. 50 shows a perspective view of a filter assembly in accordance with a twenty-first embodiment, where a first media layer with successive peaks and valleys is connected to a second media layer, with each valley including oval-shaped slit formations;

FIG. 51 shows a top view of a filter assembly in accordance with the twenty-first embodiment;

FIG. 52 shows an elevation view of a filter assembly in accordance with the twenty-first embodiment;

FIG. 53 shows a perspective view of a filter assembly in accordance with a twenty-second embodiment, where a first media layer with successive peaks and valleys is connected to a second media layer, with each valley including star-shaped slit formations;

FIG. 54 shows a top view of a filter assembly in accordance with the twenty-second embodiment;

FIG. 55 shows an elevation view of a filter assembly in accordance with the twenty-second embodiment;

FIG. 56 shows a perspective view of a filter assembly in accordance with a twenty-third embodiment, where a first media layer with successive peaks and valleys is connected to a second media layer, with each valley including hexagon-shaped slit formations;

FIG. 57 shows a top view of a filter assembly in accordance with the twenty-third embodiment;

FIG. 58 shows an elevation view of a filter assembly in accordance with the twenty-third embodiment;

FIG. 59 shows a perspective view of a filter assembly in accordance with a twenty-fourth embodiment, where a first media layer with successive peaks and valleys is connected to a second media layer, with each valley including colinear rectangle-shaped slit formations;

FIG. 60 shows a top view of a filter assembly in accordance with the twenty-fourth embodiment;

FIG. 61 shows an elevation view of a filter assembly in accordance with the twenty-fourth embodiment;

FIG. 62 shows a perspective view of a filter assembly in accordance with a twenty-fifth embodiment, where a first media layer with successive peaks and valleys is connected to a second media layer, with each valley including staggered rectangle-shaped slit formations;

FIG. 63 shows a top view of a filter assembly in accordance with the twenty-fifth embodiment;

FIG. 64 shows an elevation view of a filter assembly in accordance with the twenty-fifth embodiment;

FIG. 65 shows a perspective view of a filter assembly in accordance with a twenty-sixth embodiment, where a first media layer with successive peaks and valleys is connected to a second media layer, with each valley including rectangle-shaped slit formations having major axes extending perpendicular to the valley;

FIG. 66 shows a top view of a filter assembly in accordance with the twenty-sixth embodiment;

FIG. 67 shows an elevation view of a filter assembly in accordance with the twenty-sixth embodiment;

FIG. 68 shows a front perspective view of a filter assembly in accordance with a twenty-seventh embodiment, where a first media layer with successive peaks and valleys is connected to a second media layer, the peaks of the first media layer including oval-shaped slit formations;

FIG. 69 is similar to FIG. 68;

FIG. 70A shows three side views of three filter assemblies according to embodiments of the present disclosure;

FIG. 70B shows four differently angled views of a filter assembly according to an embodiment of the present disclosure;

FIG. 70C shows partial top views of filter assemblies having multiple slit formations of different geometries;

FIG. 71 shows a perspective view of a reusable frame assembly according to an embodiment of the present disclosure;

FIG. 72 shows a perspective view of a filter assembly in accordance with a twenty-eighth embodiment, the assembly positioned adjacent to a conventional residential filter;

FIG. 73 shows a perspective view of the filter assembly in accordance with the twenty-eighth embodiment, with the first media layer pulled away from the second media layer to reveal divots on an inner face of the first media layer;

FIG. 74 shows a perspective view of the filter assembly in accordance with the twenty-eighth embodiment, showing a slit formation visible at an outer face of the first media layer;

FIG. 75 shows a perspective view of the filter assembly in accordance with the twenty-eighth embodiment;

FIG. 76 shows a perspective view of a filter assembly in accordance with a twenty-ninth embodiment wherein a pre-filter is mated with a bowtie filter;

FIG. 77 shows a perspective view of a bowtie filter array without pre-filters installed; and

FIG. 78 shows a perspective view of the bowtie filter array with pre-filters installed;

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Non-Limiting Definitions

Definitions of one or more terms that will be used in this disclosure are described below without limitations. For a person skilled in the art, it is understood that the definitions are provided just for the sake of clarity and are intended to include more examples than just provided below.

Filter Body: Refers to the main structural component of the filter assembly, typically having a cuboid or other defined shape, configured to support various filter media and associated flaps or slit formations.

Flap: Refers to a flexible or rigid extension that protrudes from an edge of the filter body, which may be designed to extend into a slit formation when a suction force or airflow is applied, thereby enhancing the surface area for particulate collection.

Slit formation: Refers to a recessed or hollow space formed on the front face of the filter body, into which the flap may extend during use to facilitate the capture of debris or particles.

Front Face: Refers to the surface of the filter body where the slit formation is located and where the flap is positioned, facing the incoming airflow or fluid during operation.

Back Wall: Refers to the opposite surface of the front face, which may be flat, concave, or otherwise configured to support improved airflow and particulate capture.

Pleated Filter: Refers to a filter configuration where the filter media is folded or pleated to form successive peaks and valleys, increasing the effective surface area for filtration.

Media Layer: Refers to a layer of filtration material that may be configured with various shapes, slit formations, or patterns to enhance the capture of particulates and direct airflow efficiently.

Suction Force: Refers to the pressure differential applied across the filter assembly, causing airflow or fluid to pass through the filter body and encouraging particulates to accumulate on various surfaces.

Open Channels: Refers to the spaces or gaps formed between the peaks of the first media layer and the second media layer in a pleated filter configuration, enabling the movement of air or fluid through the filter.

Successive Peaks and Valleys: Refers to the alternating raised and lowered sections of a pleated filter, where valleys may include shaped slit formations that enhance particulate collection.

In Use State: Refers to the condition of the filter assembly when the flap is extended into the slit formation due to suction force or airflow, actively participating in particulate capture.

Not in Use State: Refers to the condition of the filter assembly when the flap remains in its default or original position, not yet extended into the slit formation.

Shaped Slit formation: Refers to a slit formation formed in the valley of a pleated filter, which may include various geometrical configurations such as X-shapes, plus-shapes, star-shapes, V-shapes, and others to enhance particulate capture and airflow redirection.

Spray Booth Filter: Refers to a specialized filter assembly configured to capture overspray particles in spray booths.

These definitions are provided for clarity and to ensure consistency in interpreting the scope of the invention. Additional terms used in this disclosure should be understood in their customary and ordinary meaning as recognized in the relevant technical field.

### Overview

Conventional filters often face limitations in capturing fine particulates and debris effectively. Standard filter designs typically consist of a single surface or pleated filter media that relies solely on surface area for particle collection. However, this configuration results in limited filtration capacity, particularly when airflow or suction forces cause debris accumulation on a single surface, thereby reducing overall filter efficiency. Furthermore, as particulates accumulate on the filter surface, the airflow path may become obstructed, leading to increased pressure drop, reduced suction efficiency, and decreased operational performance.

The present disclosure introduces an improved filter assembly that enhances particulate capture by incorporating flaps that extend into a slit formation when subjected to a suction force or airflow. These flaps provide additional surface areas that capture particles at multiple points, including the top surface of the flap, the flap itself, the side walls of the slit formation, and the back wall of the filter. The slit formations may adopt various geometrical configurations such as X-shaped, plus-shaped, star-shaped, and other shapes to further optimize airflow and enhance debris capture. In pleated filter configurations, successive peaks and valleys are formed, where the valleys may include slit formations with predefined shapes that further contribute to improved filtration efficiency. The design increases the overall surface area exposed to the airflow and minimizes the likelihood of clogging or obstruction.

The disclosed filter assembly offers significant technical advancements over conventional filter designs. By integrating dynamically extending flaps and geometrically shaped slit formations, the assembly increases the effective surface area available for particulate capture without increasing the overall dimensions of the filter. The flaps, in conjunction with the slit formations, direct airflow through multiple layers of the filter media, reducing pressure drop and enhancing the longevity and efficiency of the filter. Additionally, the inclusion of various slit formation shapes, such as X, plus, star, and others, optimizes airflow distribution and debris capture based on the type and size of particles being filtered. In pleated configurations, the successive peaks and valleys provide structured pathways for airflow, ensuring consistent filtration performance and preventing localized clogging.

These advancements make the disclosed filter assembly particularly suitable for demanding applications such as spray booth environments, where maintaining high filtration efficiency and minimizing maintenance requirements are crucial. The combination of flaps, slit formations, and pleated configurations ensures a more uniform distribution of particulates and improved overall performance, addressing the limitations of traditional filter designs.

The filter assemblies described herein may be fabricated from a variety of materials. The filter media may include, but is not limited to, polyester, polypropylene, polyurethane, polyethylene, polyethylene foam, polyurethane foam, polyphenylene sulfide, fiberglass, spun glass, micro glass, cotton, nylon, felt, paper, cardboard, metal, acrylic fiber, organic fiber, animal hair, wood, plastic, or any combination thereof. In some aspects, the filter media may be electrostatic, configured to generate or hold an electrical charge to attract and capture particulates. The filter media may have any suitable MERV rating as determined for a particular application. The filter media may be fabricated as a single layer of equal density, graduated density, or conformed density, or may be fabricated from multiple layers of media. In some aspects, the filter media may include a tackifier or binder to help hold particulates and provide a more uniform configuration. Structural components of the filter assemblies, such as frames or supports, may be fabricated from materials including, but not limited to, metal, wood, polymeric substances, rubber, fiberglass, alloys, plastic, cardboard, or any combination thereof. Adjacent filter components may be coupled together by any suitable method including, but not limited to, stitching, heat staking, gluing, laminating, ultrasonically welding, or any combination thereof. In some aspects, the filter media may be supported by a mesh, adhesive, or wiring to aid in maintaining shape as forces are exerted upon the media. The filter media may also be finished to enhance effectiveness, with finishes including, but not limited to, singed, glazed, oleophobic, fire retardant, acid resistant, anti-static, mold resistant, moisture resistant, microbial growth resistant, or any combination thereof.

### Exemplary Implementations/Embodiments

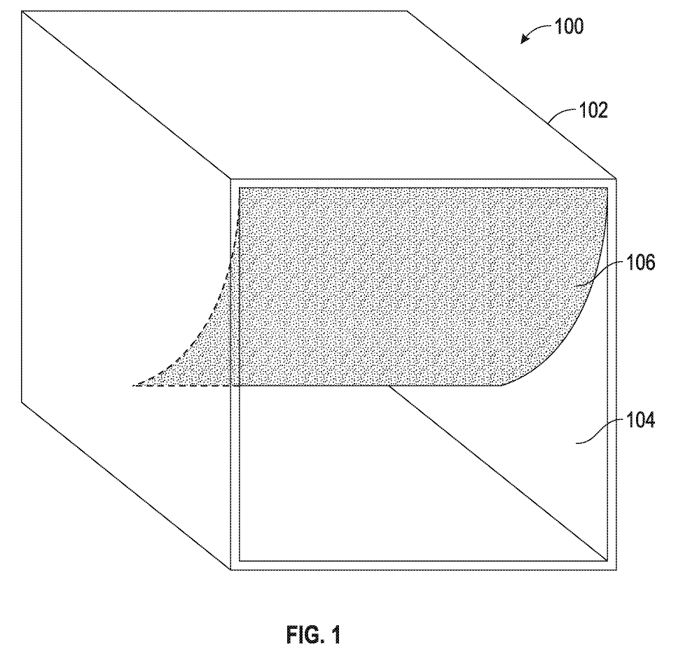

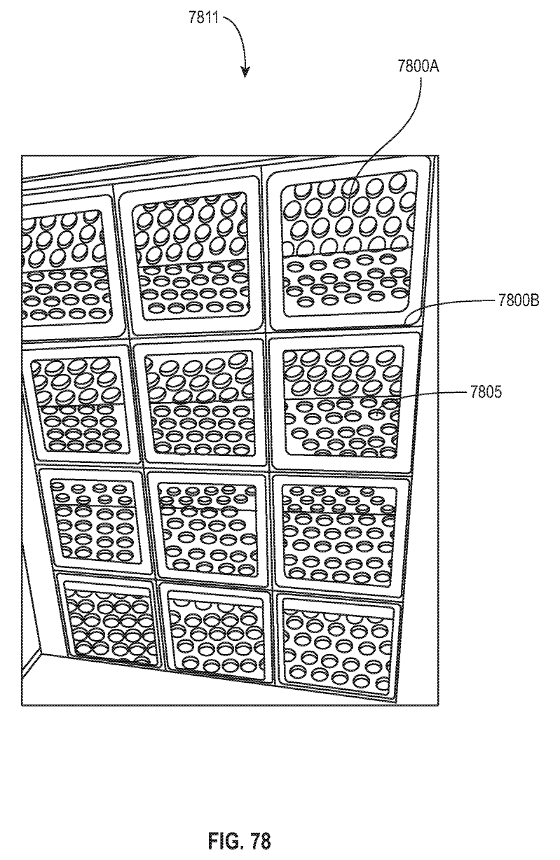

The following detailed descriptions of FIGS. 1 through 78 pertain to various embodiments of a filter assembly designed to enhance particulate capture efficiency, in applications such as HVAC units, spray booths and other systems and application where air flow through the system is filtered. These descriptions incorporate reference numerals to identify specific components and structural features, facilitating a comprehensive understanding of each embodiment.

FIG. 1 illustrates a perspective view of a filter assembly 100 according to a first embodiment. The filter assembly comprises a filter body 102 having a rear face and side walls each formed from filter material and at least partially defining an internal cavity. A slit formation 104 is centrally formed in a front face of the filter body 102, and a flap 106 extends downward from the top edge of the slit formation 104. Under suction or airflow, the flap 106 bends or deflects inward into the slit formation 104, allowing particulate matter to accumulate on the flap surface, the side walls, and the back wall. This design increases the overall surface area for debris capture, thereby enhancing filtration efficiency.

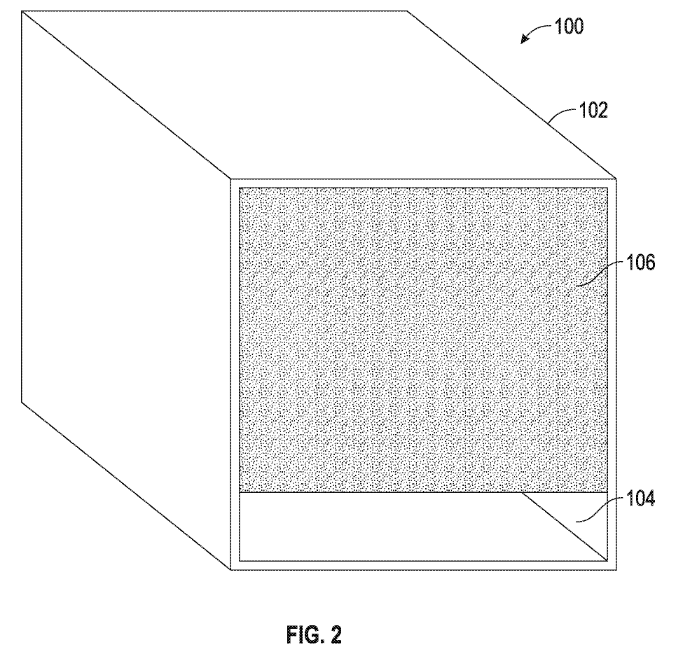

FIG. 2 provides a front view of the filter assembly 100 from the first embodiment, highlighting the positioning of the slit formation 104 and the flap 106 extending from the top edge. The slit formation 104 is centrally located on the front face of the filter body 102, creating a recessed area optimized for particulate collection.

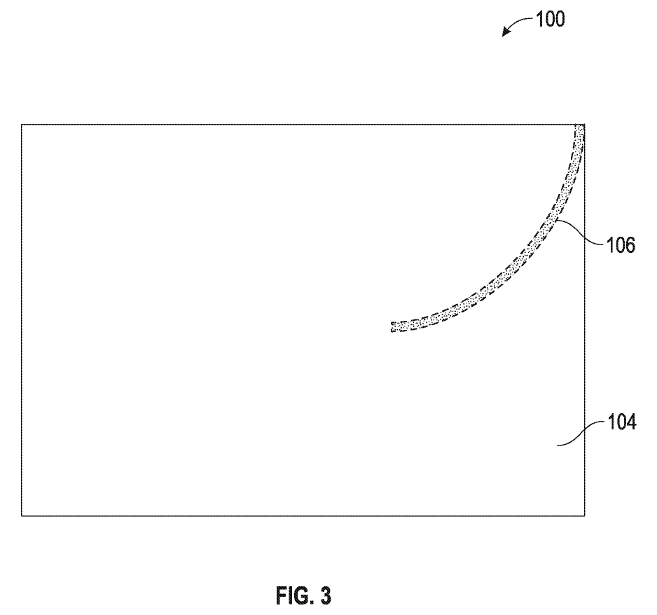

FIG. 3 depicts a side view of the filter assembly 100 from the first embodiment, illustrating the orientation and movement of the flap 106 when subjected to airflow or suction. The flap 106 bends or deflects into the slit formation 104 during operation, providing an additional surface for particulate deposition and preventing clogging on a single surface.

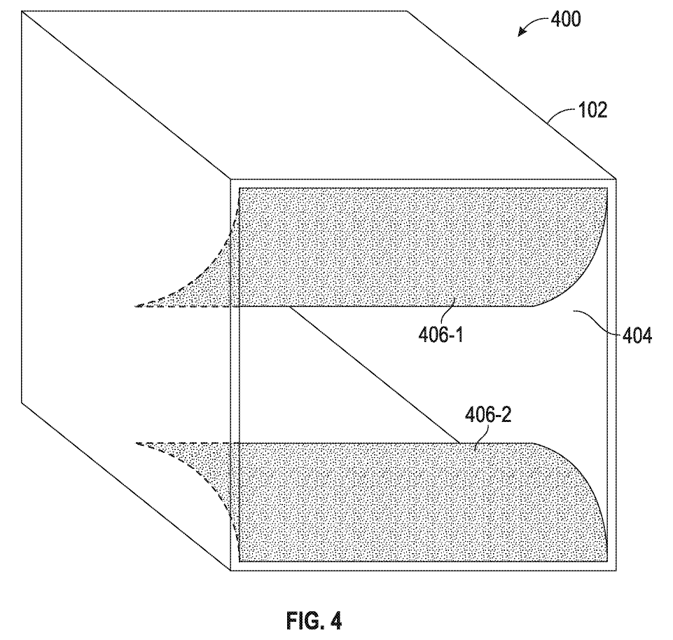

FIG. 4 shows a perspective view of a filter assembly 400 in accordance with a second embodiment. In this design, the filter assembly 400 features a slit formation 404 formed between a first flap 406-1 extending from the top edge and a second flap 406-2 extending from the bottom edge of the front face. Both flaps 406-1, 406-2 bend or deflect inward under suction, capturing debris on multiple surfaces within the slit formation 404 and enhancing filtration by increasing the surface area for particulate capture.

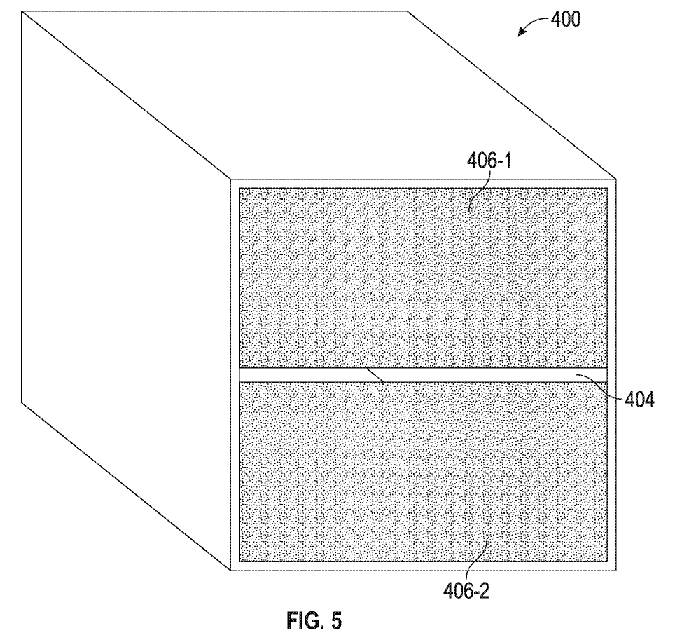

FIG. 5 presents a front view of the filter assembly 400 from the second embodiment, depicting the arrangement of the first and second flaps 406-1, 406-2 around the slit formation 404. The dual-flap configuration provides a symmetrical design that facilitates efficient airflow redirection and particulate capture.

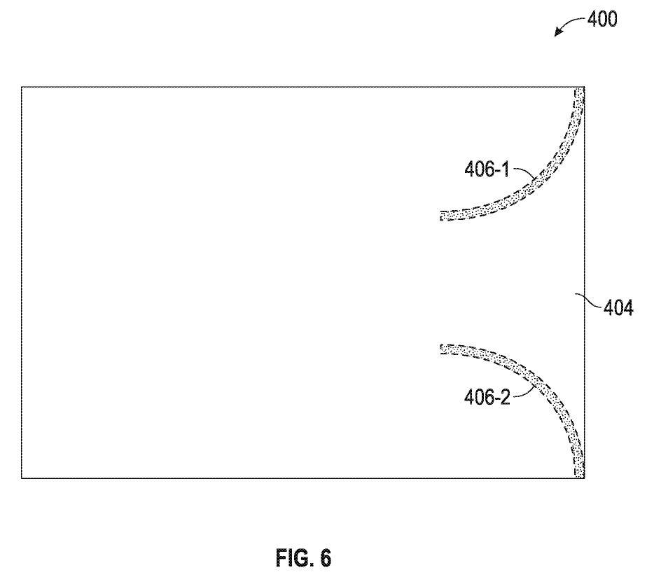

FIG. 6 offers a side view of the filter assembly 400 from the second embodiment, highlighting the orientation and movement of the flaps 406-1, 406-2 as they extend into the slit formation 404 under suction. This inward bend or deflecting of the flaps creates multiple surfaces for debris accumulation, thereby improving the overall filtration performance.

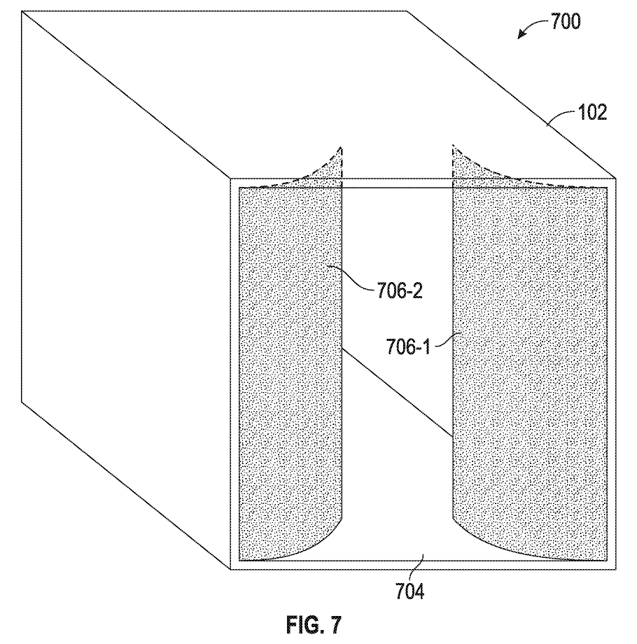

FIG. 7 illustrates a perspective view of a filter assembly 700 according to a third embodiment. Here, the filter includes a slit formation 704 formed between a first flap 706-1 extending from a first side edge and a second flap 706-2 extending from a second side edge of the front face. This lateral flap configuration enables particulate capture along the side surfaces of the slit formation 704 and the flap surfaces, optimizing the filter for different airflow patterns.

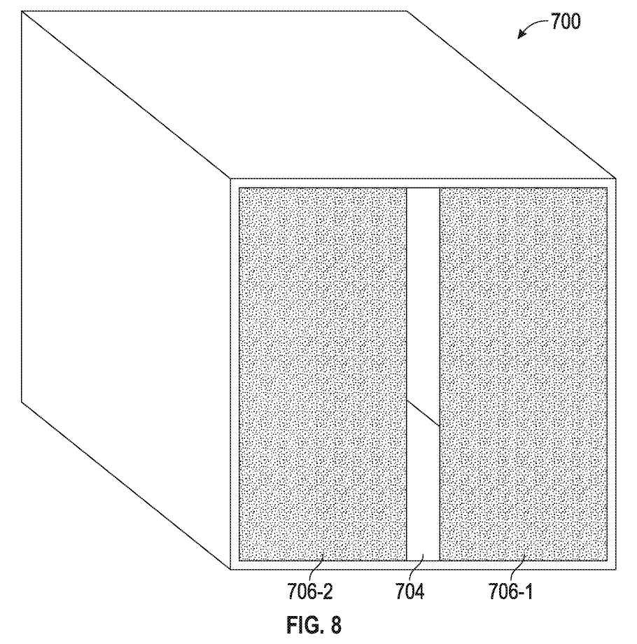

FIG. 8 provides a front view of the filter assembly 700 from the third embodiment, depicting the relative positioning of the flaps 706-1, 706-2 extending from the side edges toward the slit formation 704. This arrangement ensures that airflow is directed through multiple filtration surfaces, enhancing debris capture efficiency.

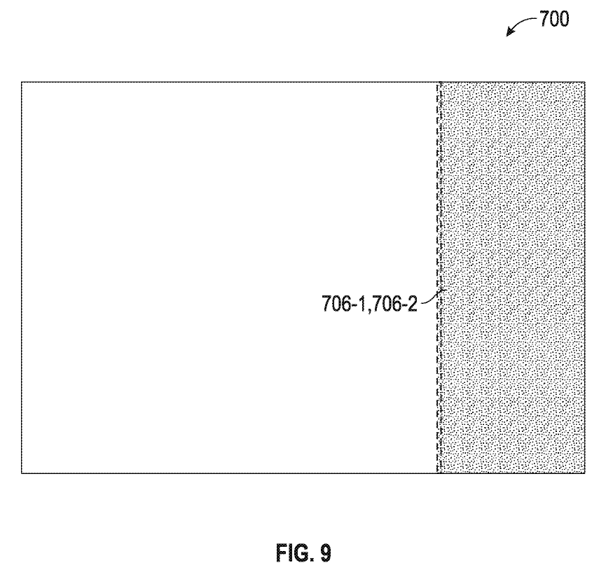

FIG. 9 shows a side view of the filter assembly 700 from the third embodiment, illustrating the movement and positioning of the flaps 706-1, 706-2 during operation when subjected to airflow or suction forces. The inward bend or deflecting of the flaps into the slit formation 704 provides additional surfaces for particulate deposition, thereby improving filtration efficiency.

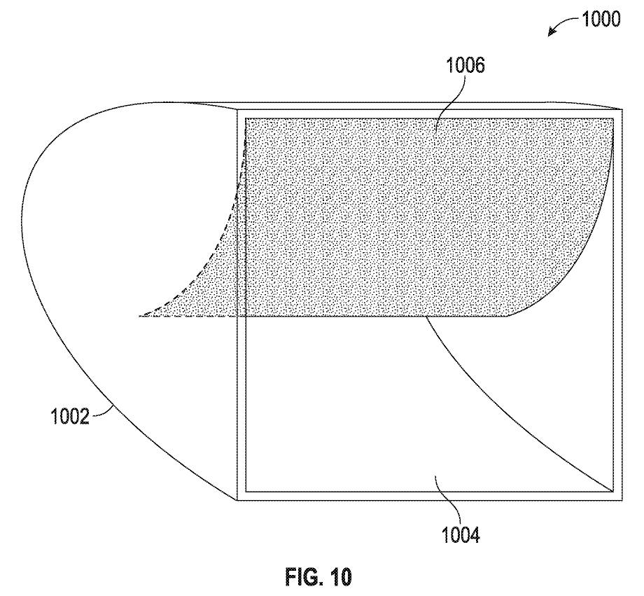

FIG. 10 depicts a perspective view of a filter assembly 1000 in accordance with a fourth embodiment. In this design, the slit formation 1004 is positioned on the front face of the filter body 1002, and the flap 1006 extending from the top edge features a modified shape to alter airflow and improve particulate capture. This modification demonstrates the adaptability of the filter design to various operational requirements.

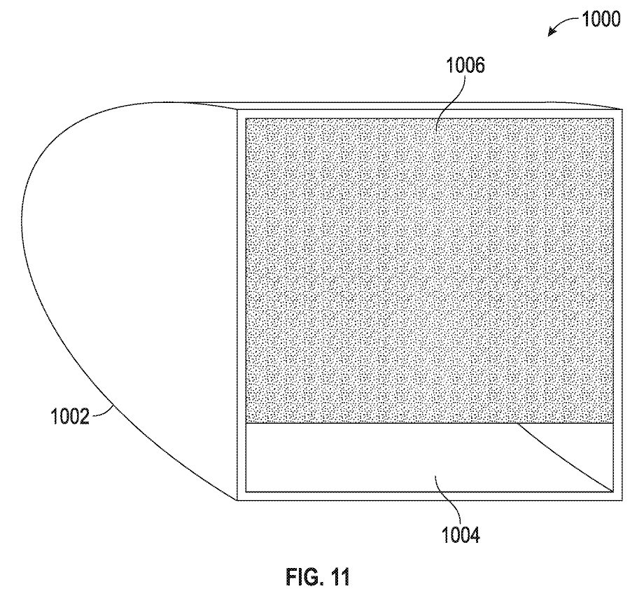

FIG. 11 presents a front view of the filter assembly 1000 from the fourth embodiment, highlighting the slit formation 1004 and the modified flap 1006 shape. The tailored flap design allows for customized airflow patterns, enhancing the filter's ability to capture particulates effectively.

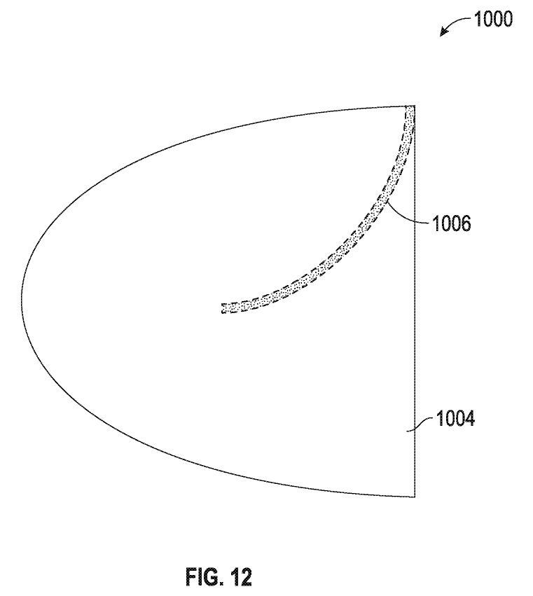

FIG. 12 offers a side view of the filter assembly 1000 from the fourth embodiment, depicting the orientation and movement of the modified flap 1006 under suction. The unique flap shape contributes to optimized airflow dynamics and improved particulate capture.

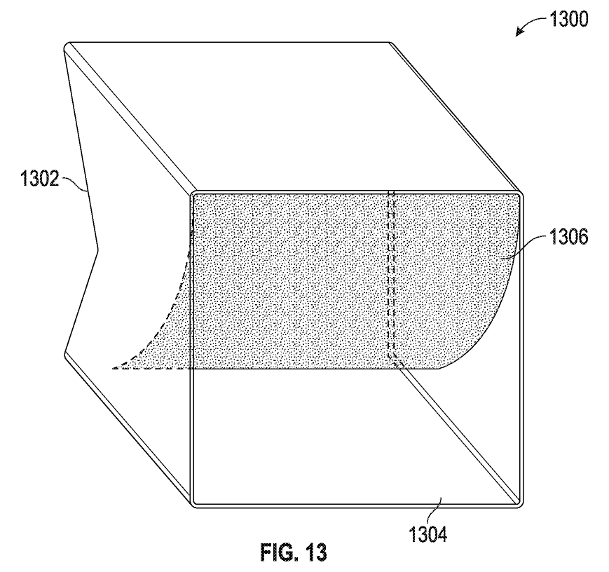

FIG. 13 illustrates a perspective view of a filter assembly 1300 according to a fifth embodiment. In this design, the back wall of the filter body 1302 is fabricated in a concave manner to form a V-shape. The slit formation 1304 is formed in the front face, and a flap 1306 hangs from the top edge of the front face above the slit formation 1304, providing an enhanced surface for particulate capture. This configuration increases the surface area for debris accumulation and improves filtration efficiency.

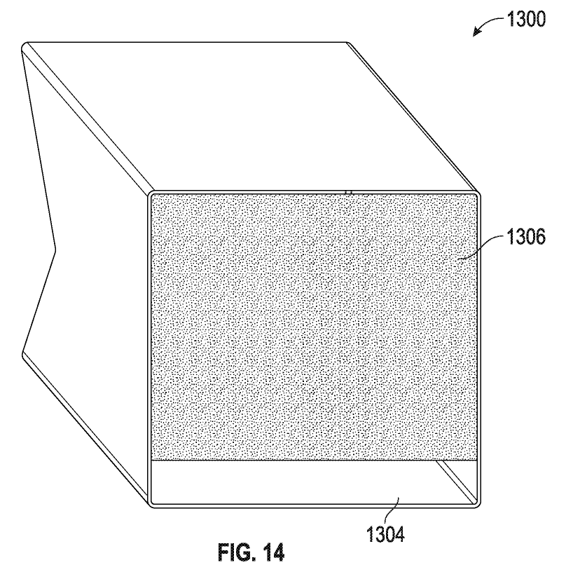

FIG. 14 provides a front view of the filter assembly 1300 from the fifth embodiment, illustrating the concave back wall and the positioning of the slit formation 1304 and flap 1306. The V-shaped back wall design enhances airflow dynamics, directing particulates toward the slit formation and flap surfaces.

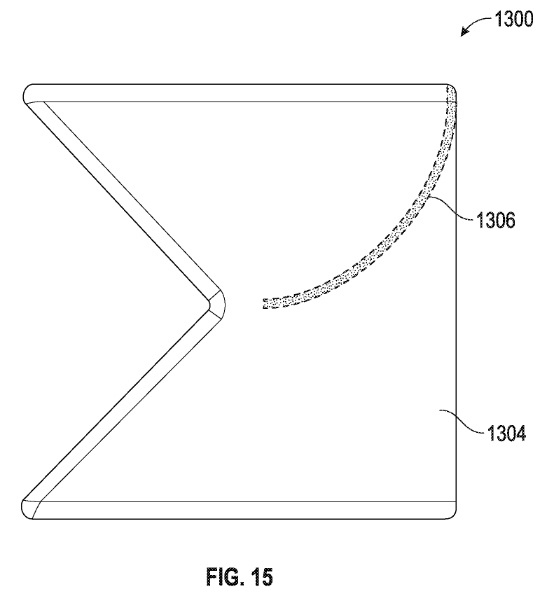

FIG. 15 shows a side view of the filter assembly 1300 from the fifth embodiment, depicting the concave back wall of the filter body 1302. The flap 1306 extends downward from the top edge of the slit formation 1304, and when suction is applied, it bends or deflects inward toward the slit formation. The concave back wall increases the surface area where particulates can accumulate, improving overall filtration efficiency.

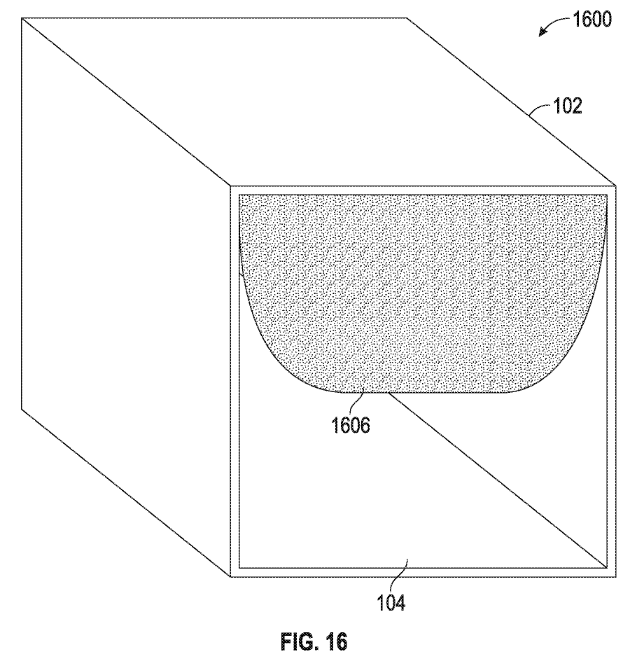

FIG. 16 illustrates a perspective view of a filter assembly 1600 according to a sixth embodiment. The filter body 102 maintains a cuboid shape, with a slit formation 104 formed on the front face. A flap 1606 extends downward from the top edge of the slit formation 104. In this embodiment, the flap 1606 features rounded corners at its ends, reducing sharp edges that may restrict airflow. The rounded corners facilitate smoother airflow and reduce turbulence, enhancing particulate capture.

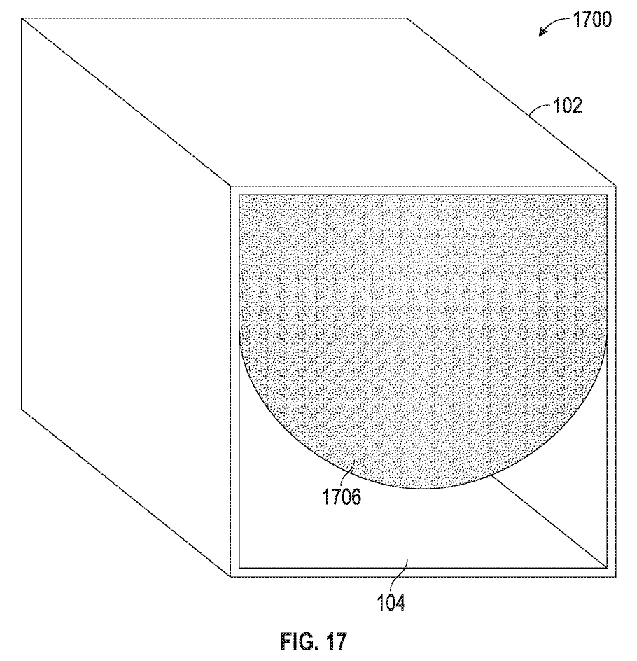

FIG. 17 shows a perspective view of a filter assembly 1700 from a seventh embodiment. Similar to the sixth embodiment, the filter body 102 includes a slit formation 104 formed on the front face. However, the flap 1706 extending from the top edge features a semi-circular edge toward the slit formation. The semi-circular design promotes uniform airflow distribution across the slit formation, ensuring even particulate deposition across multiple surfaces.

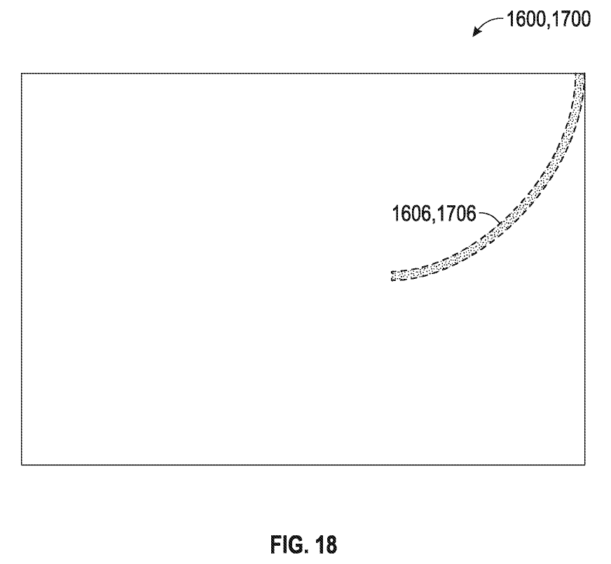

FIG. 18 depicts a side view of the filter assemblies 1600 and 1700 in accordance with the sixth and seventh embodiments, illustrating the positioning and inward bend or deflecting of the respective flaps 1606, 1706 when suction is applied. The rounded and semi-circular designs optimize airflow and enhance filtration performance by increasing contact with the flap surfaces.

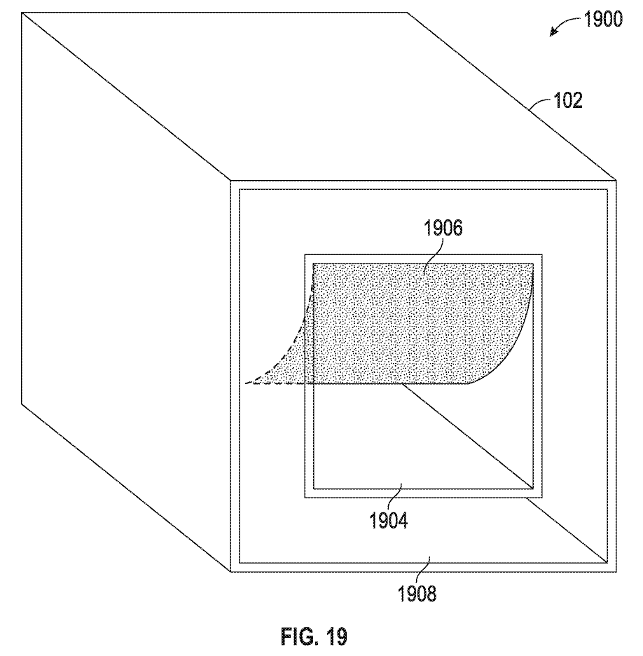

FIG. 19 illustrates a perspective view of a filter assembly 1900 according to an eighth embodiment. The filter body 102 is cuboid-shaped with a central slit formation 1904 positioned in the front face 1908. A flap 1906 extends from the top edge of the slit formation 1904 and bends or deflects inward under suction. This configuration captures particulates across multiple surfaces, including the flap, the side walls, and the back wall of the slit formation.

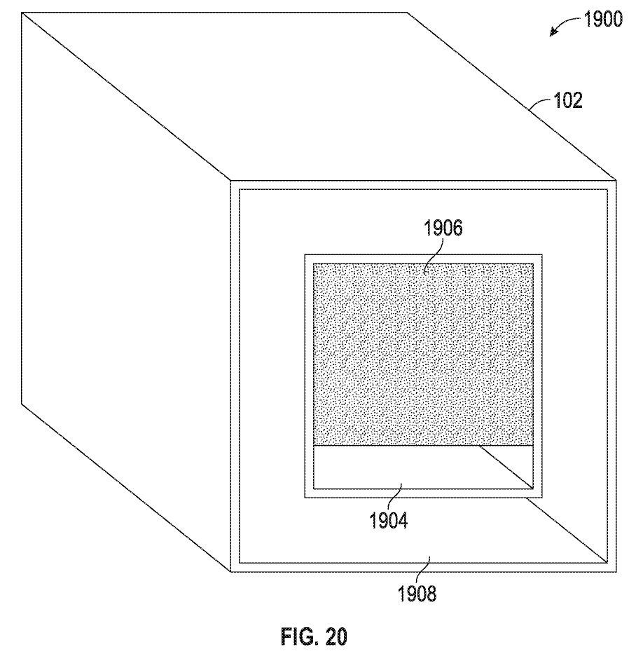

FIG. 20 shows a front view of the filter assembly 1900, highlighting the slit formation 1904 and the positioning of the flap 1906 from the top edge of the slit formation. The flap’s central location enhances debris capture by directing airflow into the slit formation.

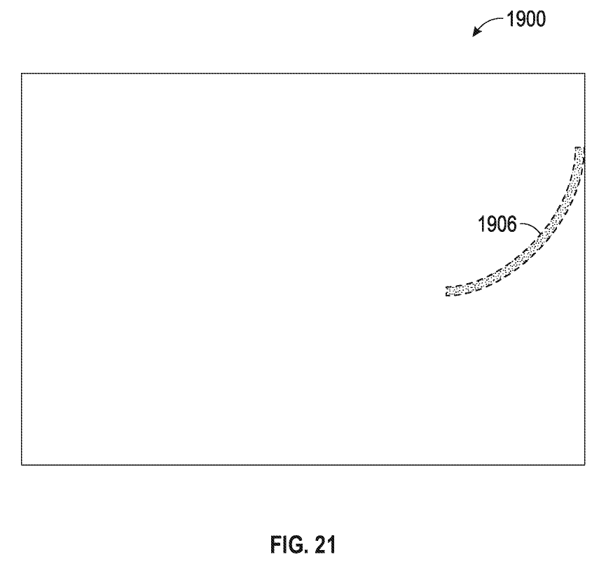

FIG. 21 depicts a side view of the filter assembly 1900, illustrating the movement of the flap 1906 under suction and its positioning relative to the slit formation 1904. The configuration enhances surface area for particulate accumulation.

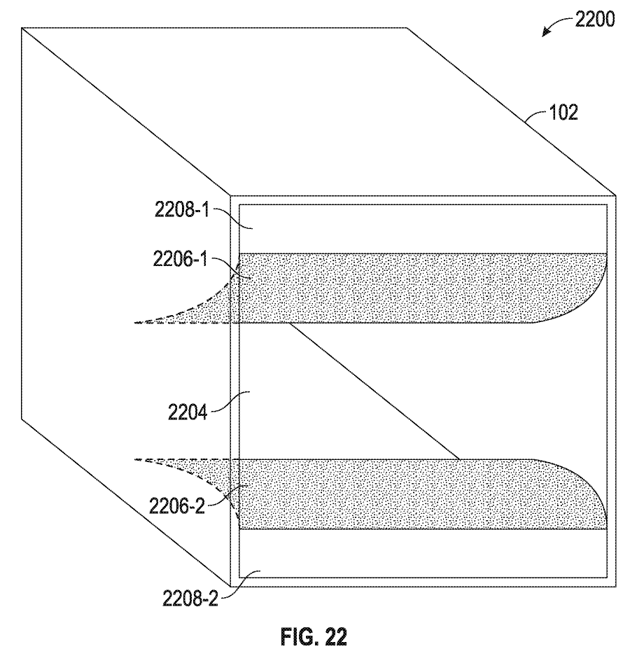

FIG. 22 provides a perspective view of a filter assembly 2200 from a ninth embodiment. The filter body 102 has a cuboid shape with a slit formation 2204 formed in the front face 2208-1, 2208-2. This embodiment features a first flap 2206-1 extending from the top edge of the top front face 2208-1 and a second flap 2206-2 extending from the bottom edge of the bottom front face 2208-2. The slit formation 2204 is formed between these two flaps, allowing debris to accumulate on multiple surfaces when the flaps bend or deflect inward.

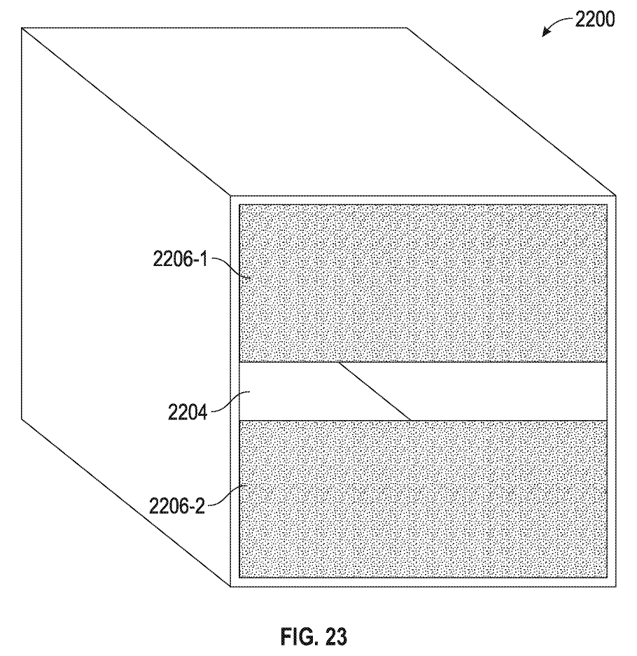

FIG. 23 shows a front view of the filter assembly 2200, depicting the arrangement of the slit formation 2204 and the first and second flaps 2206-1, 2206-2. The dual-flap configuration enhances airflow control and increases particulate capture efficiency.

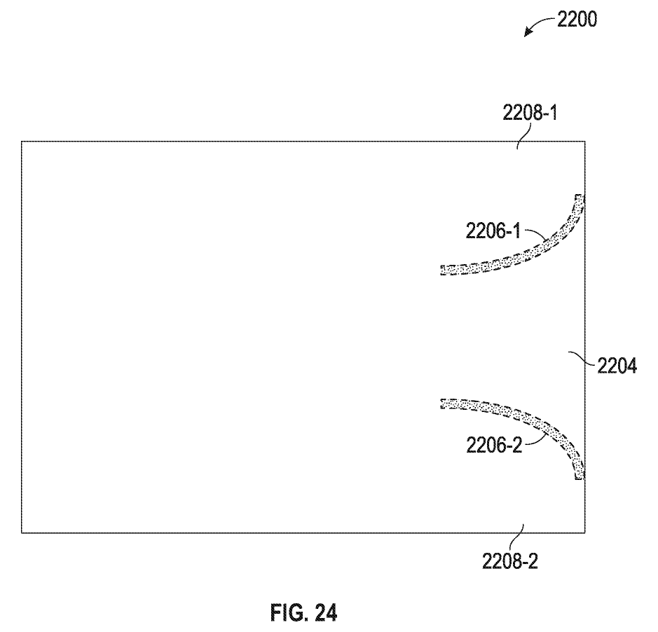

FIG. 24 illustrates a side view of the filter assembly 2200, highlighting the inward bend or deflecting of the flaps 2206-1, 2206-2 into the slit formation 2204 when subjected to suction, thereby increasing the available surface area for debris capture.

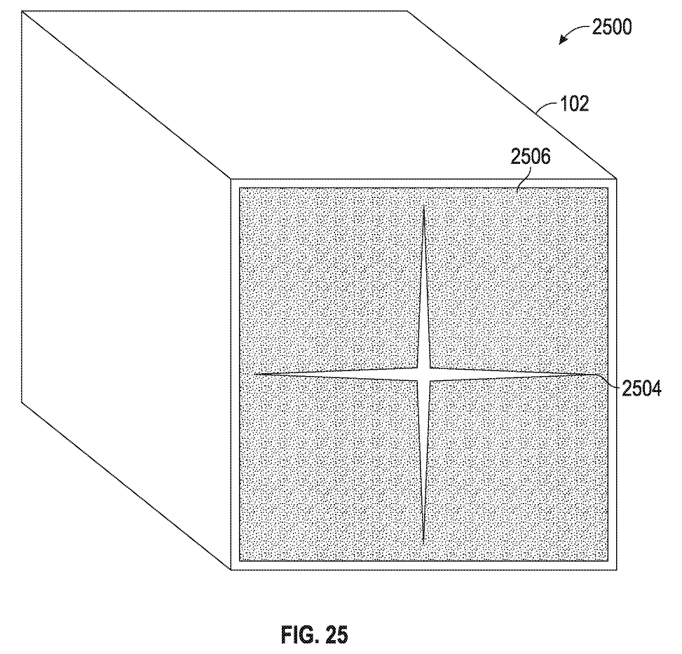

FIG. 25 shows a perspective view of a filter assembly 2500 from a tenth embodiment. The filter body 102 maintains a cuboid shape. A front filter or face of the filter body has one or more slits defining a cross or star-shaped shape. The slits forms flaps 2506 (e.g. four flaps) that are connected to the remainder of the front filter or face adjacent a side edges of the front face. This multi-flap design captures debris along all the slit formation's edges, increasing filtration effectiveness. FIG. 25 illustrates the flaps 2506 when no negative pressure or positive pressure is applied to the flaps, such that the flaps may be disposed over the front of the filter and be generally coplanar.

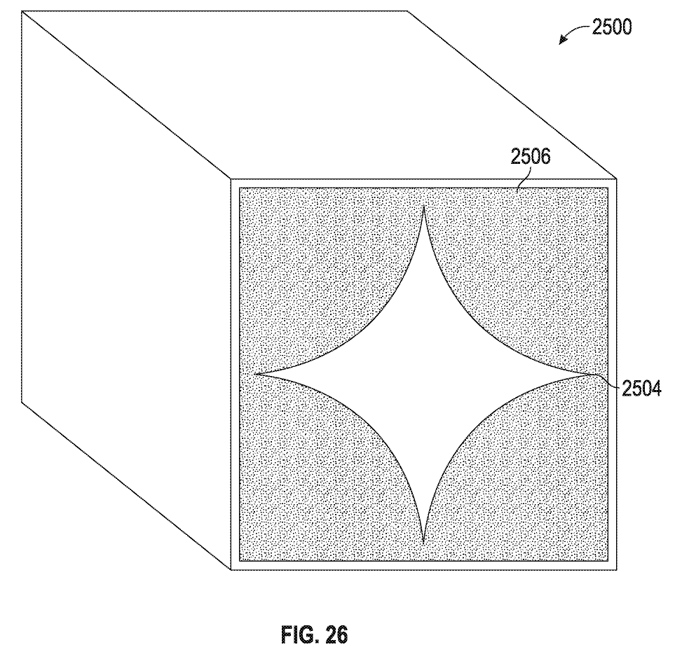

FIG. 26 provides a front view of the filter assembly 2500, showing the flaps 2506 defined by the cross-shaped slit formation 2504 bend or deflecting or folding inward into the slit formation 2204 when a negative or positive pressure is applied. The folding of the flaps 2506 increases the open area of the front face (e.g., defines an enlarged diamond-shaped opening) while still enabling the flaps to capture debris or particulate in air flowing over the flaps inside the filter body 102.

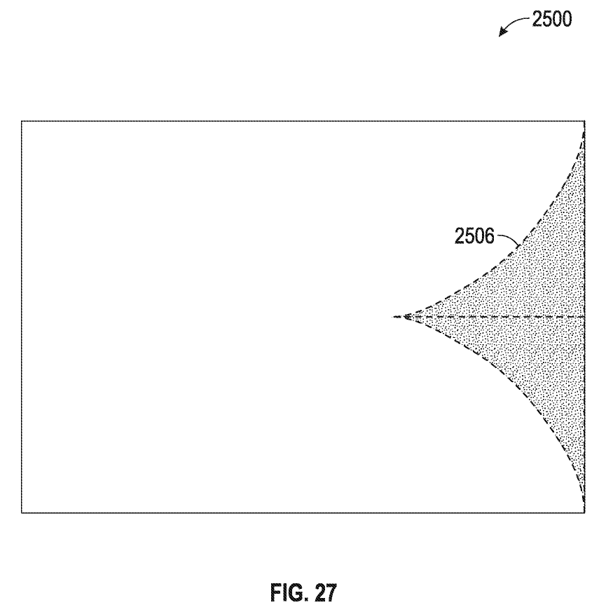

FIG. 27 depicts a schematic cross section of the filter assembly 2500 in FIG. 26, showing the inward bend or deflecting of the flap 2506 into the slit formation 2504 under negative or positive pressure. As can be seen, the plus-shaped design creates multiple regions for airflow redirection and particulate capture.

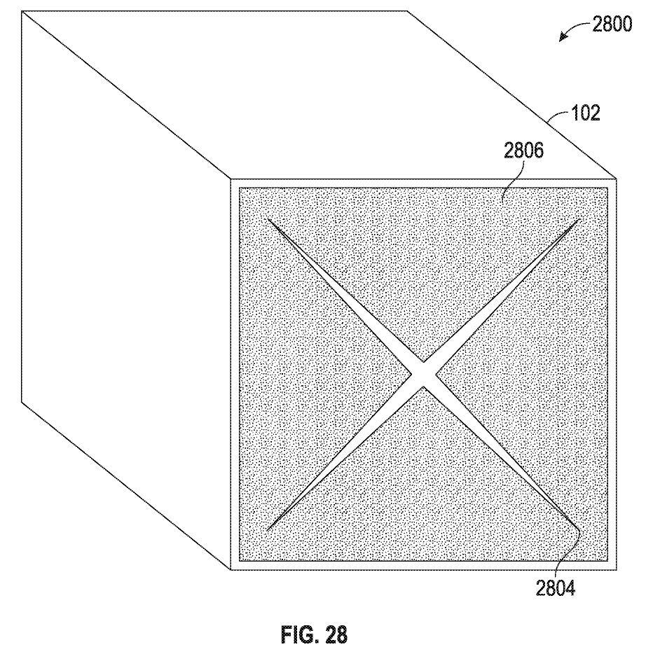

FIG. 28 illustrates a perspective view of a filter assembly 2800 according to an eleventh embodiment. Similar to the tenth embodiment, the filter body 102 has a cuboid shape, but the slit(s) have a cross or X-shape. The slits forms flaps 2506 (e.g. four flaps) that are connected to the remainder of the front filter or face adjacent a side edges of the front face. This multi-flap design captures debris along all the slit formation's edges, increasing filtration effectiveness. FIG. 28 illustrates the flaps 2506 when no negative pressure or positive pressure is applied to the flaps, such that the flaps may be disposed over the front of the filter and be generally coplanar.

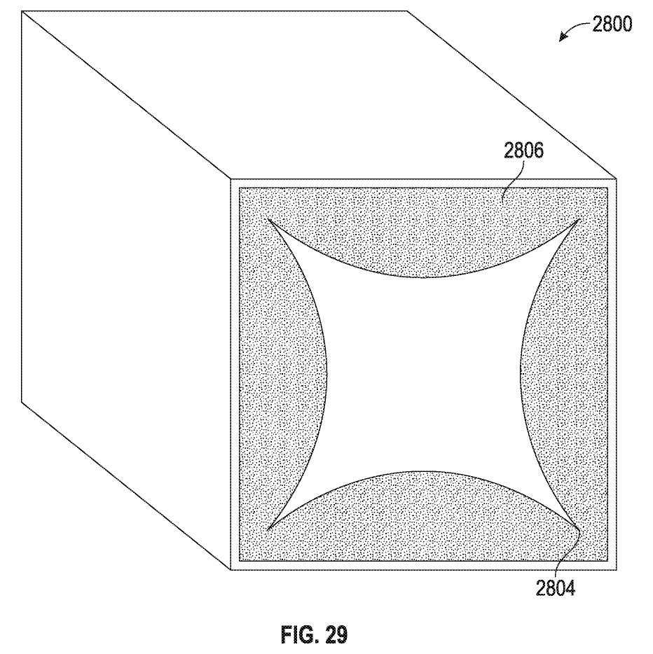

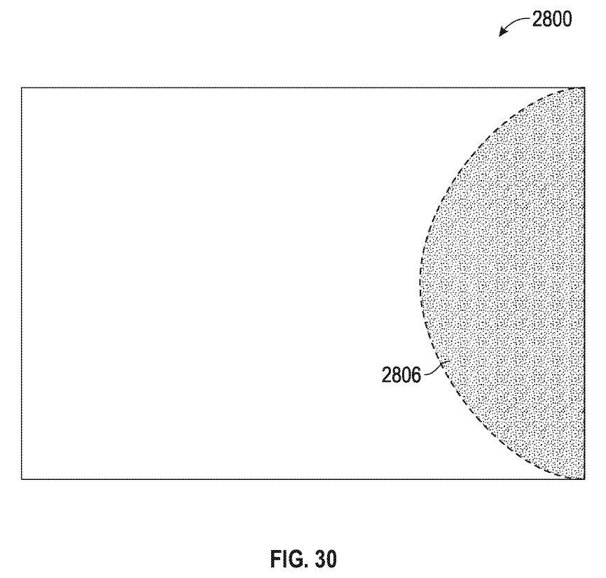

FIGS. 29 and 30 are similar to FIGS. 26 and 28, but showing the eleventh embodiment.

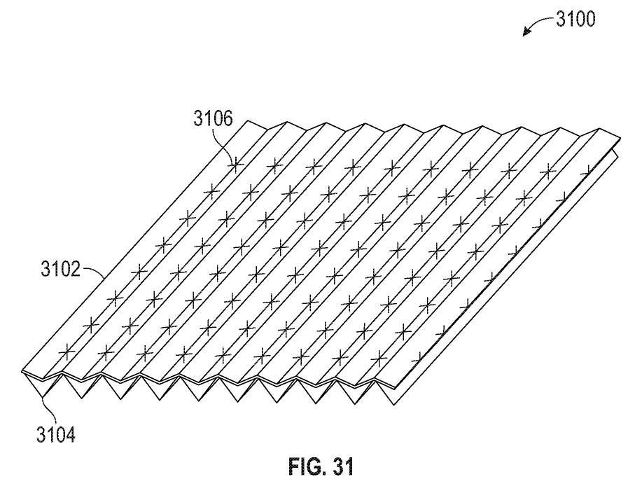

FIG. 31 illustrates a perspective view of a filter assembly 3100 according to a twelfth embodiment. This design includes a first media layer 3102 and a second media layer 3104, where the first media layer is formed with successive peaks and valleys. Each valley includes slot(s) having an X-shaped formation 3106, and the first media layer 3102 is connected through the peaks to the second media layer 3104, forming a series of open channels for airflow.

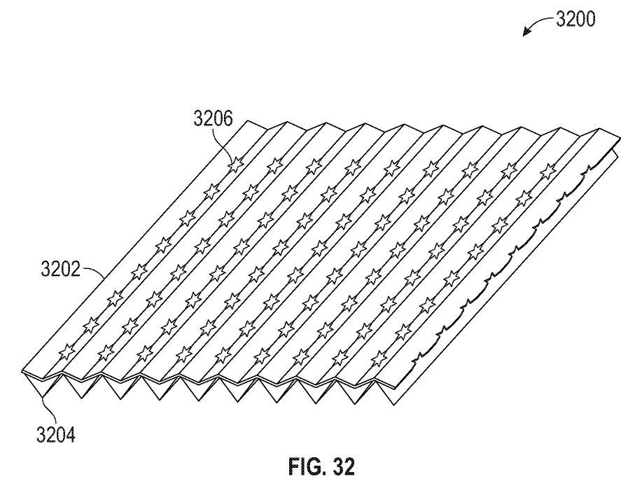

FIG. 32 depicts a perspective view of a filter assembly 3200 from a thirteenth embodiment. Similar to the twelfth embodiment, the first media layer 3202 features peaks and valleys, but each valley includes star-shaped slit formations. The first media layer 3202 is connected through the peaks to the second media layer 3204, forming open channels for directing airflow.

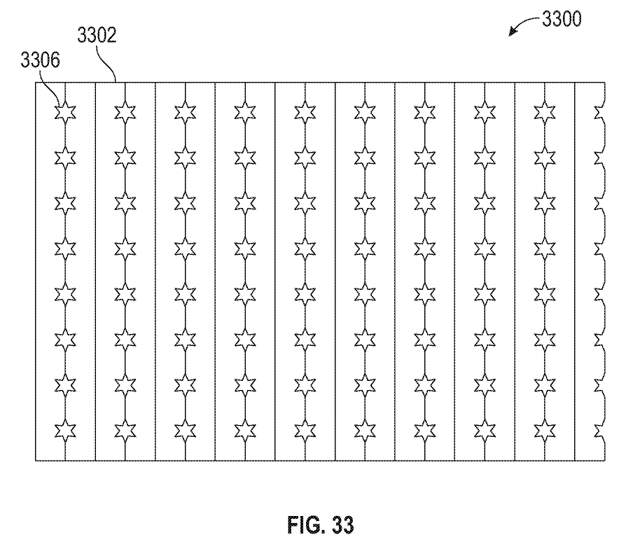

FIG. 33 shows a top view of the filter assembly 3300 according to the thirteenth embodiment (e.g., as shown at FIG. 32), illustrating the arrangement of the star-shaped slit formations 3306 within the valleys of the first media layer 3302. The top view shows the distribution of the star-shaped slit formations across the filter assembly 3300, demonstrating the pattern configuration that enhances filtration surface area.

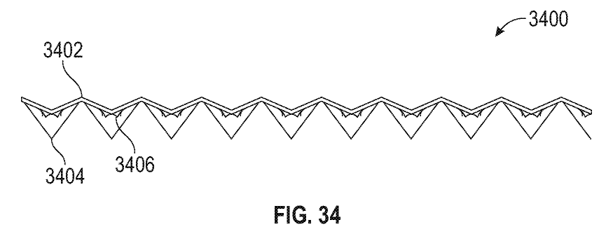

FIG. 34 provides an elevation view of the filter assembly 3400 of the thirteenth embodiment, depicting the side profile of the pleated configuration with the star-shaped slit formations positioned in the valleys between the first media layer 3402 and the second media layer 3404.

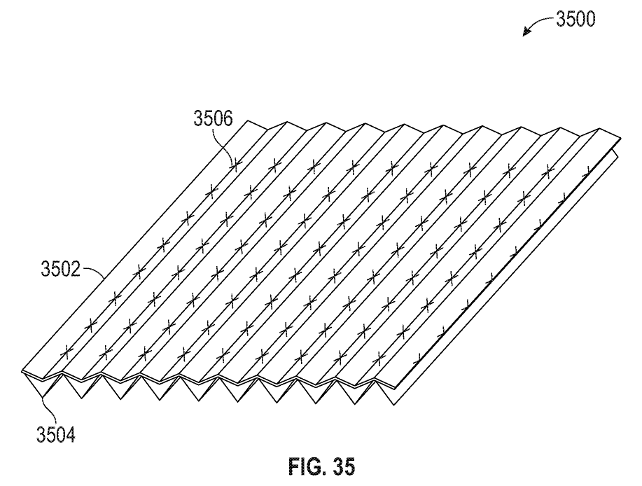

FIG. 35 a perspective view of the filter assembly 3500 according to a fourteenth embodiment. Similar to previous embodiments, the first media layer 3502 features peaks and valleys, but each valley includes X-shaped slit formations 3506. The first media layer 3502 is connected through the peaks to the second media layer 3504, forming open channels for directing airflow.

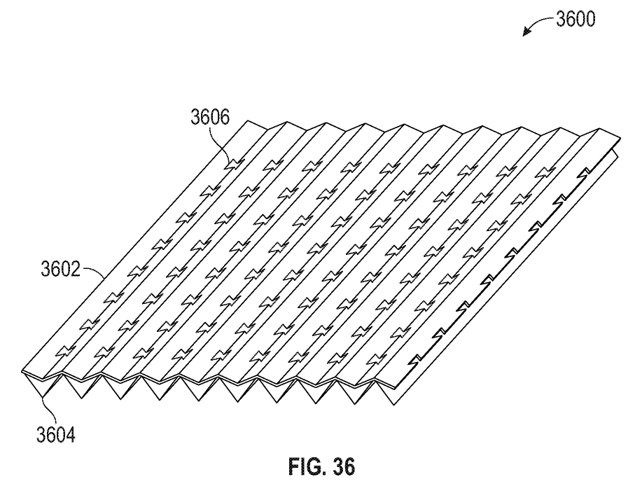

FIG. 36 shows a perspective view of the filter assembly 3600 according to a fifteenth embodiment. The first media layer 3602 features peaks and valleys, where each valley includes bowtie-shaped slit formations 3606. The peaks connect the first media layer 3602 to the second media layer 3604, enhancing airflow through the formed channels.

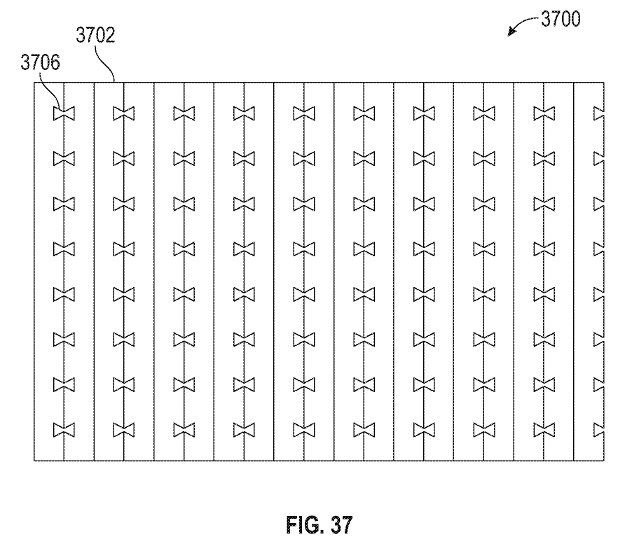

FIG. 37 shows a top view of the filter assembly 3700 according to the fifteenth embodiment, illustrating the arrangement of the bowtie-shaped slit formations 3706 within the valleys of the first media layer 3702.

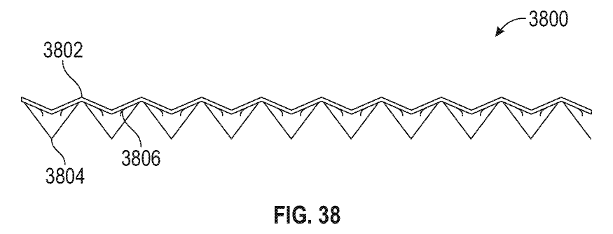

FIG. 38 is an elevation view of the filter assembly 3800 according to the fifteenth embodiment. FIG. 38 shows the pleated configuration of the first and second media layers 3802, 3804, with the bowtie-shaped slit formations 3806 positioned in the valleys between the first media layer and the second media layer.

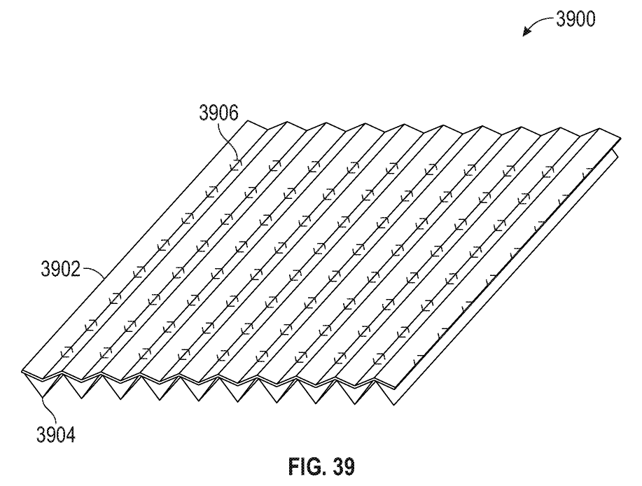

FIG. 39 shows a perspective view of a filter assembly 3900 according to a sixteenth embodiment. The first media layer 3902 features peaks and valleys, where each valley includes arrow-shaped slit formations 3906. The peaks connect the first media layer 3902 to the second media layer 3904, enhancing airflow through the formed channels (arrow-shaped slit formations 3906).

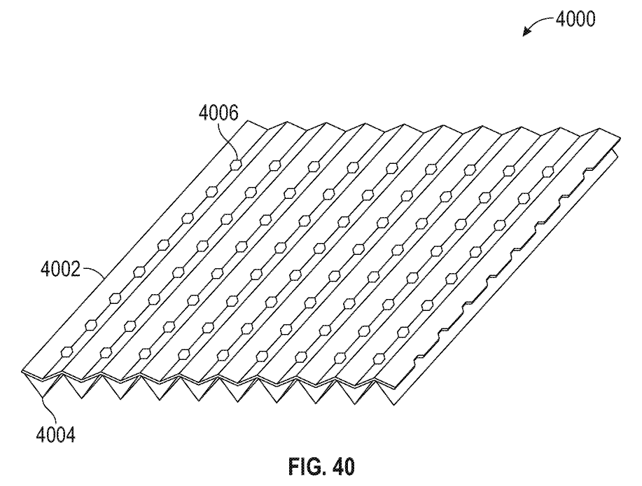

FIG. 40 shows a perspective view of a filter assembly 4000 according to a seventeenth embodiment. The first media layer 4002 includes successive peaks and valleys, where each valley includes hexagon-shaped slit formations 4006. The peaks connect the first media layer 4002 to the second media layer 4004, improving filtration through multiple channels.

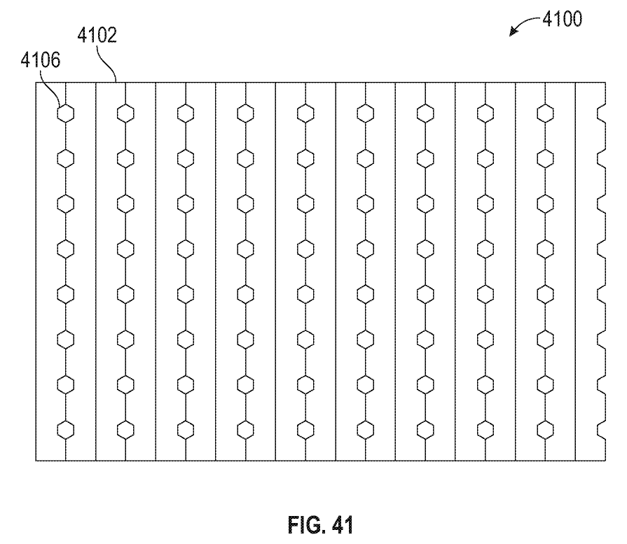

FIG. 41 shows a top view of the filter assembly 4100 according to the seventeenth embodiment, illustrating the arrangement of the hexagon-shaped slit formations 4106 within the valleys of the first media layer 4102.

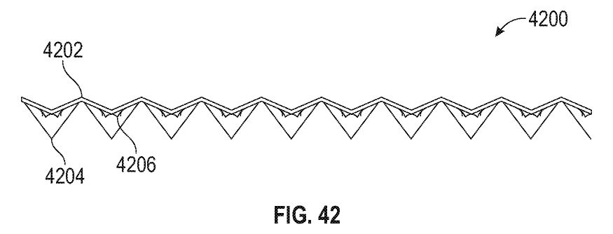

FIG. 42 shows an elevation view of the filter assembly 4200 according to the seventeenth embodiment, depicting the side profile of the pleated configuration with the hexagon-shaped slit formations 4206 positioned in the valleys of the first media layer 4202.

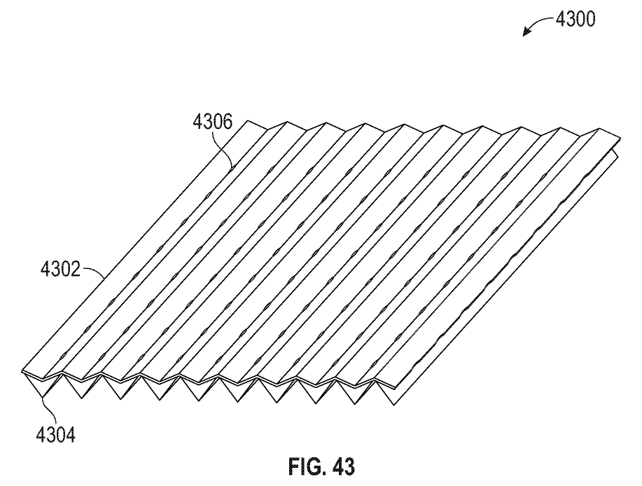

FIG. 43 shows a perspective view of a filter assembly 4300 according to an eighteenth embodiment. The first media layer 4302 includes successive peaks and valleys, where each valley includes line-shaped slit formations 4306. The peaks connect the first media layer 4302 to the second media layer 4304, improving filtration through multiple channels (line-shaped slit formations 4306).

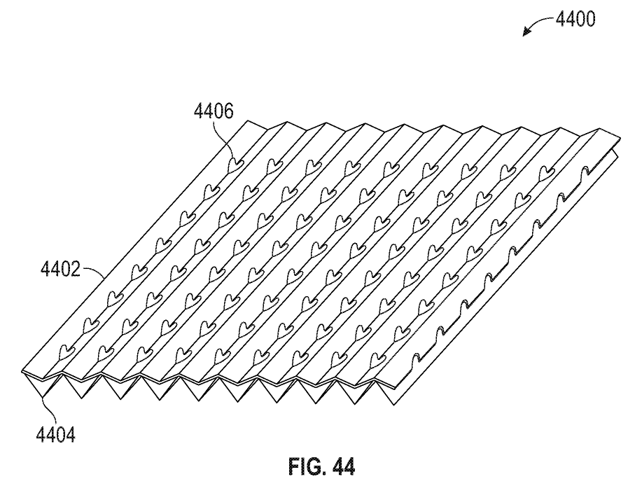

FIG. 44 shows a perspective view of a filter assembly 4400 according to a nineteenth embodiment. The first media layer 4402 is structured with peaks and valleys, where each valley includes heart-shaped slit formations 4406. The peaks connect the first media layer 4402 to the second media layer 4404, forming channels that enhance airflow and improve debris capture efficiency.

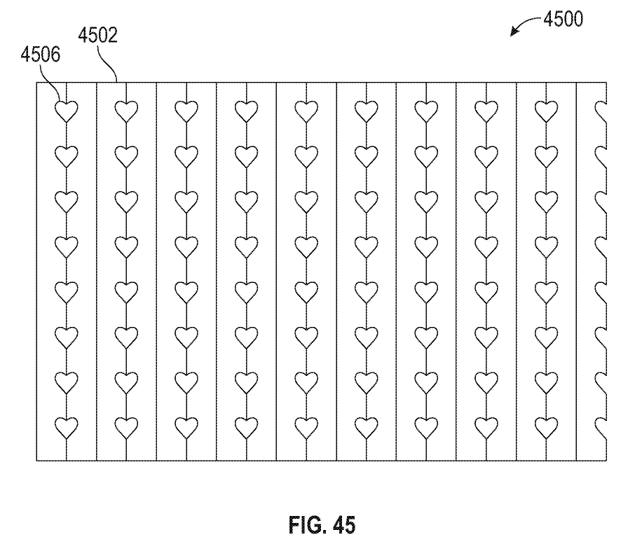

FIG. 45 shows a top view of the filter assembly 4500 according to the nineteenth embodiment, illustrating the arrangement of the heart-shaped slit formations 4506 within the valleys of the first media layer 4502.

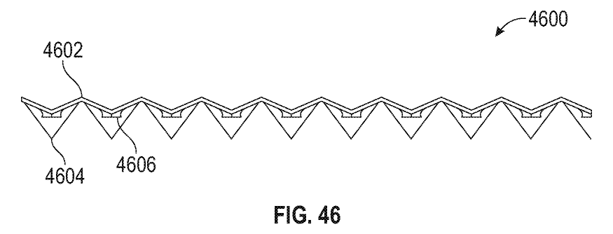

FIG. 46 shows an elevation view of the filter assembly 4600 according to the nineteenth embodiment, depicting the pleated configuration of the assembly with the heart-shaped slit formations 4606 positioned in the valleys of the first media layer 4602.

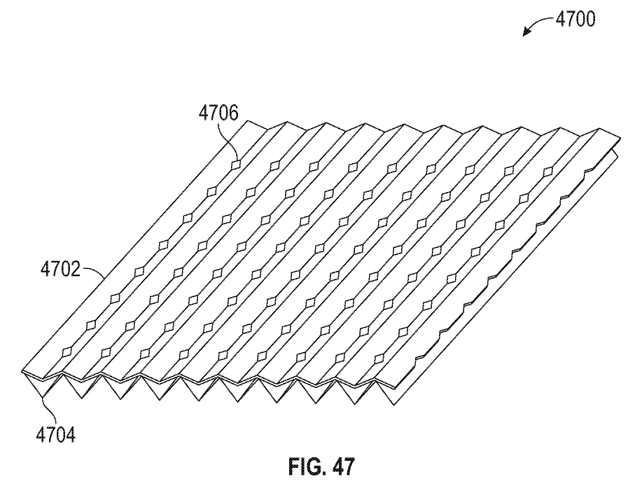

FIG. 47 shows a perspective view of a filter assembly 4700 according to a twentieth embodiment. First and second media layers 4702, 4704 are configured with successive peaks and valleys. The first media layer 4702 includes rhombus-shaped slit formations 4706 at the valleys thereof. The rhombus-shaped slit formations 4706 provide additional surface area for particulate capture and enhance filtration efficiency.

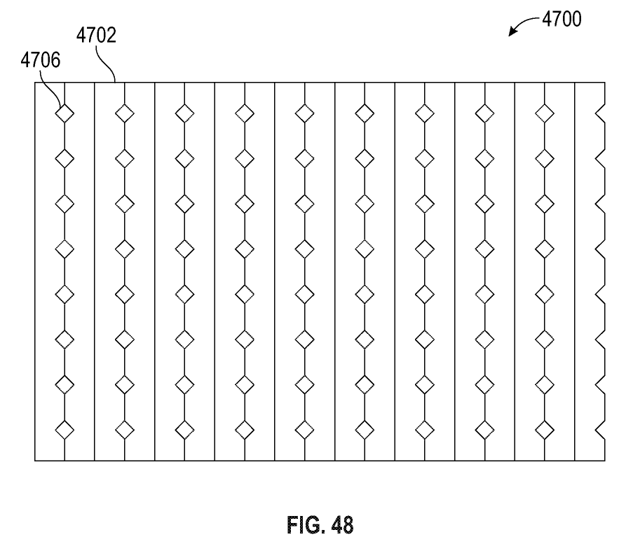

FIG. 48 shows a top view of the filter assembly 4700 according to the twentieth embodiment, illustrating the arrangement of the rhombus-shaped slit formations 4706 within the valleys of the first media layer 4702.

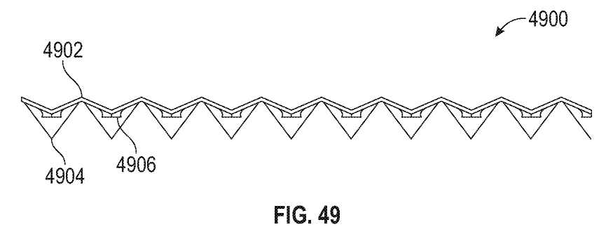

FIG. 49 shows an elevation view of the filter assembly 4900 according to the twentieth embodiment, depicting the pleated configuration with the rhombus-shaped slit formations 4906 positioned in the valleys of the first media layer 4902.

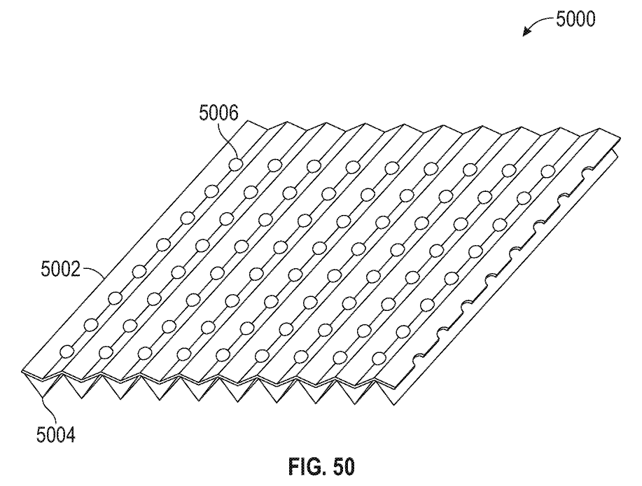

FIG. 50 shows a perspective view of a filter assembly 5000 according to a twenty-first embodiment. A first media layer 5002 features peaks and valleys, where each valley includes oval-shaped slit formations 5006. The peaks connect the first media layer 5002 to a second media layer 5004, forming open channels (oval-shaped slit formations 5006) for directing airflow.

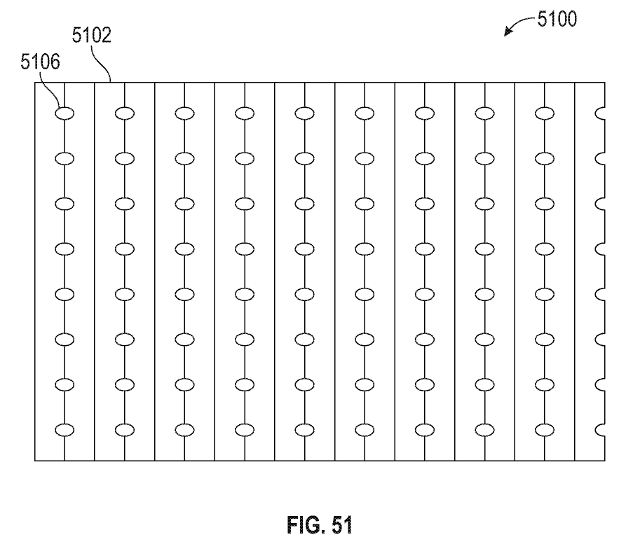

FIG. 51 shows a top view of the filter assembly 5100 according to the twenty-first embodiment, illustrating the arrangement of the oval-shaped slit formations 5106 within the valleys of the first media layer 5102.

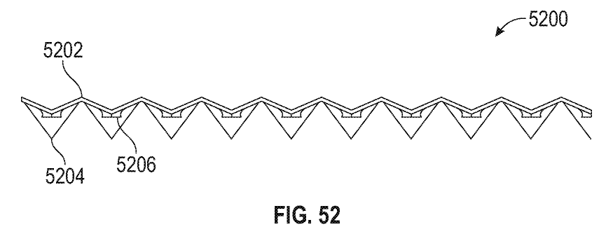

FIG. 52 shows an elevation view of the filter assembly 5200 according to the twenty-first embodiment, depicting the pleated configuration with the oval-shaped slit formations 5206 positioned in the valleys of the first media layer 5202.

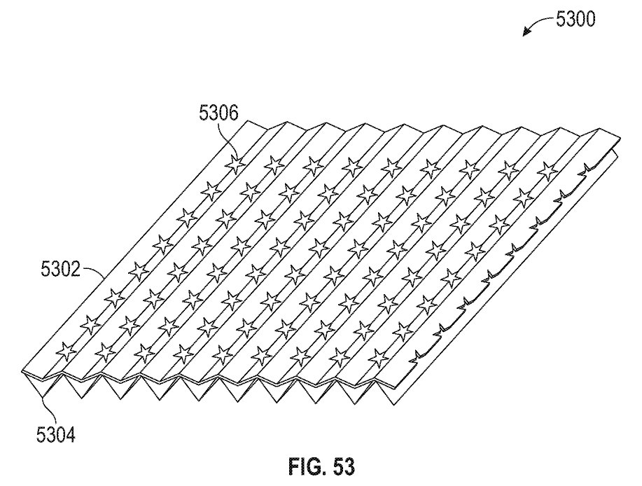

FIG. 53 shows a perspective view of a filter assembly 5300 according to a twenty-second embodiment. A first media layer 5302 features peaks and valleys, where each valley includes star-shaped slit formations 5306. The peaks connect the first media layer 5302 to a second media layer 5304, forming channels that enhance particulate capture.

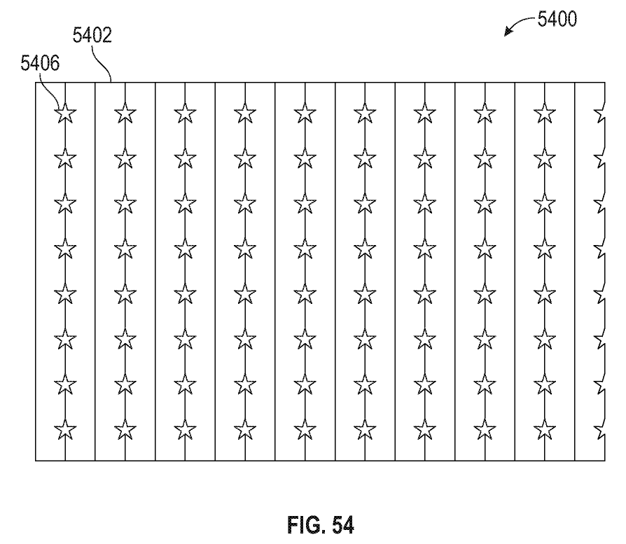

FIG. 54 shows a top view of the filter assembly 5400 according to the twenty-second embodiment, illustrating the arrangement of the star-shaped slit formations 5406 within the valleys of the first media layer 5402.

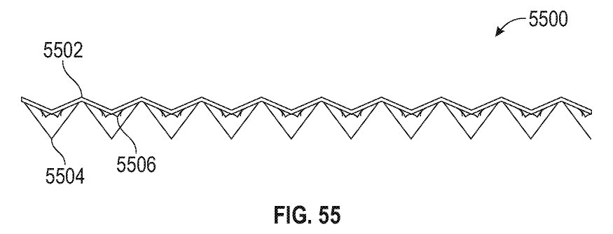

FIG. 55 shows an elevation view of the filter assembly 5500 according to the twenty-second embodiment, depicting the pleated configuration with the star-shaped slit formations 5506 positioned in the valleys between the first media layer 5502 and the second media layer 5504.

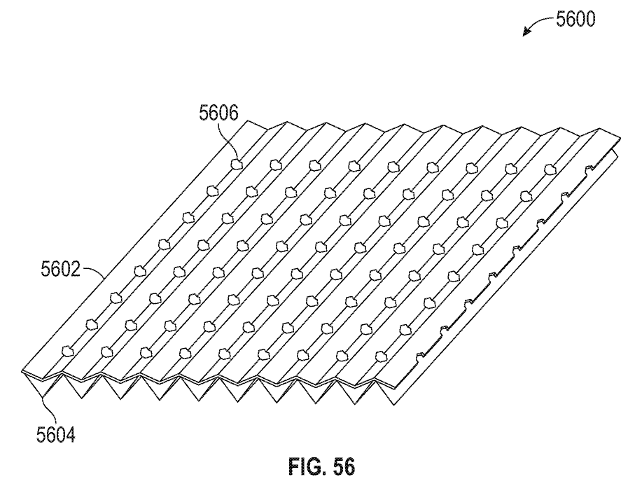

FIG. 56 shows a perspective view of a filter assembly 5600 according to a twenty-third embodiment. A first media layer 5602 features peaks and valleys, where each valley includes hexagon-shaped slit formations 5606. The hexagon-shaped slit formations 5606 of the twenty-third embodiment of the filter assembly 5600 differ from the hexagon-shaped slit formations 4006 of the seventeenth embodiment of the filter assembly 4000 with respect to their orientation relative to the valleys (e.g., by a 30-degree angular offset). The peaks connect the first media layer 5602 to a second media layer 5604, improving filtration through multiple channels.

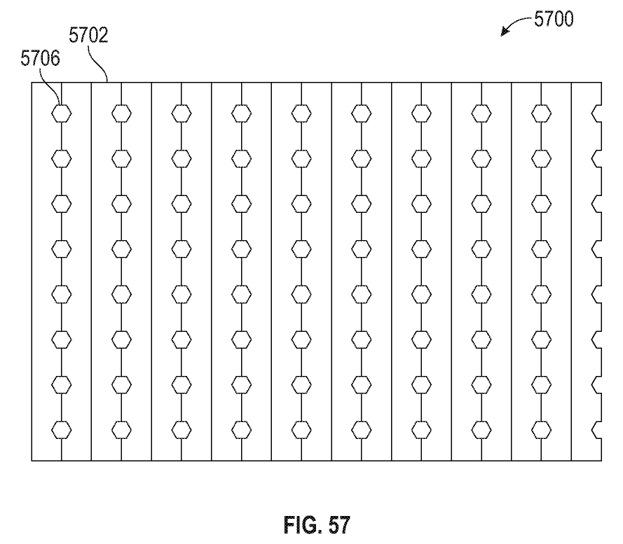

FIG. 57 shows a top view of the filter assembly 5700 according to the twenty-third embodiment, illustrating the arrangement of the hexagon-shaped slit formations 5706 within the valleys of the first media layer 5702.

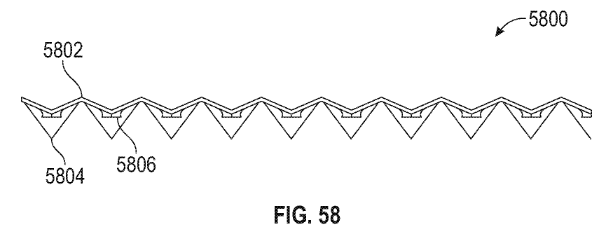

FIG. 58 shows an elevation view of the filter assembly 5800 according to the twenty-third embodiment, depicting the pleated configuration with the hexagon-shaped slit formations 5806 positioned in the valleys between the first media layer 5802 and the second media layer 5804.

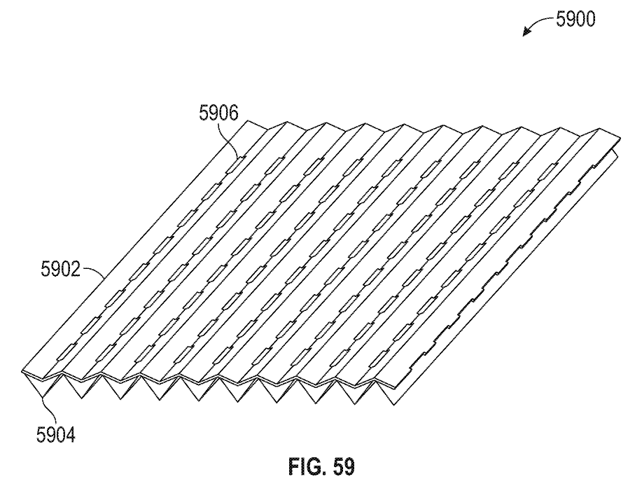

FIG. 59 shows a perspective view of a filter assembly 5900 according to a twenty-fourth embodiment. A first media layer 5902 features peaks and valleys, where each valley includes colinear rectangle-shaped slit formations 5906. The peaks connect the first media layer 5902 to a second media layer 5904. The rectangle-shaped slit formations 5906 extend with their major axes (e.g., along the long edge) parallel to the valleys, forming open channels that facilitate effective particulate capture.

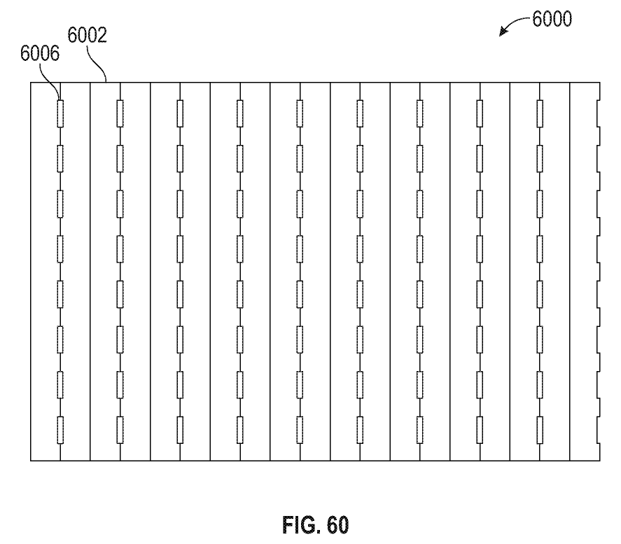

FIG. 60 shows a top view of the filter assembly 6000 according to the twenty-fourth embodiment, illustrating the arrangement of the colinear rectangle-shaped slit formations 6006 within the valleys of the first media layer 6002.

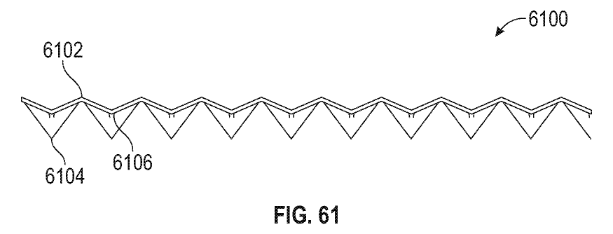

FIG. 61 shows an elevation view of the filter assembly 6100 according to the twenty-fourth embodiment, depicting the pleated configuration with the colinear rectangle-shaped slit formations 6106 positioned in the valleys between the first media layer 6102 and the second media layer 6104.

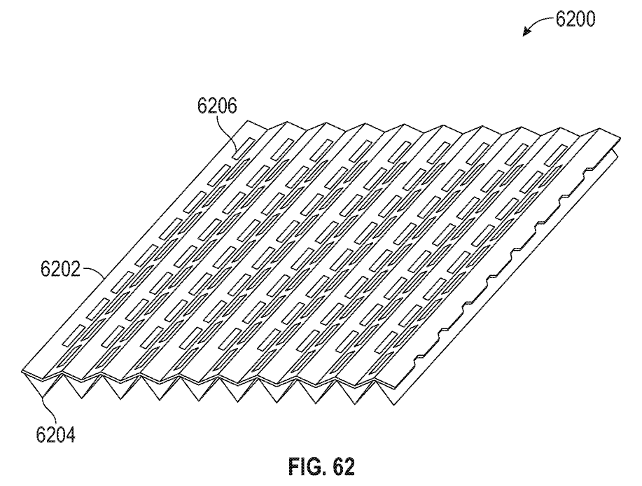

FIG. 62 shows a perspective view of a filter assembly 6200 according to a twenty-fifth embodiment. A first media layer 6202 features peaks and valleys, where each valley includes staggered rectangle-shaped slit formations 6206. The peaks connect the first media layer 6202 to a second media layer 6204. The staggered arrangement provides varied airflow patterns and enhanced debris capture.

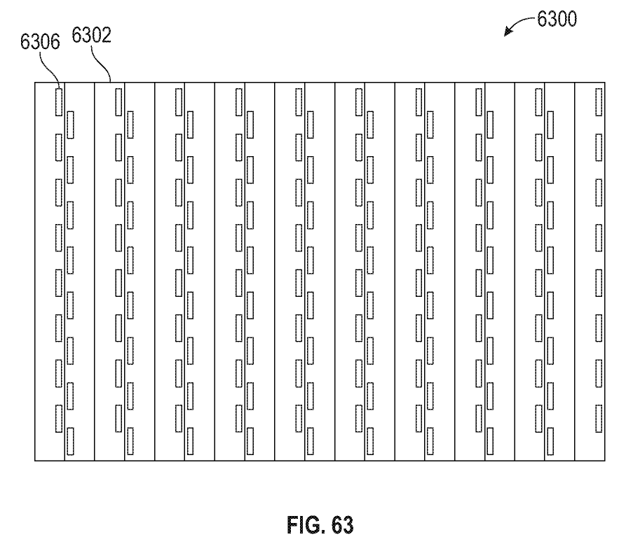

FIG. 63 shows a top view of the filter assembly 6300 according to the twenty-fifth embodiment, illustrating the arrangement of the staggered rectangle-shaped slit formations 6306 within the valleys of the first media layer 6302.

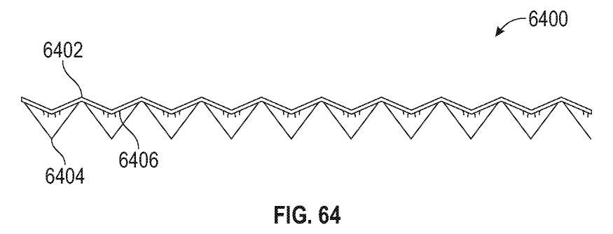

FIG. 64 shows an elevation view of the filter assembly 6400 according to the twenty-fifth embodiment, depicting the pleated configuration with the staggered rectangle-shaped slit formations 6406 positioned in the valleys of the first media layer 6402 and the second media layer 6404.

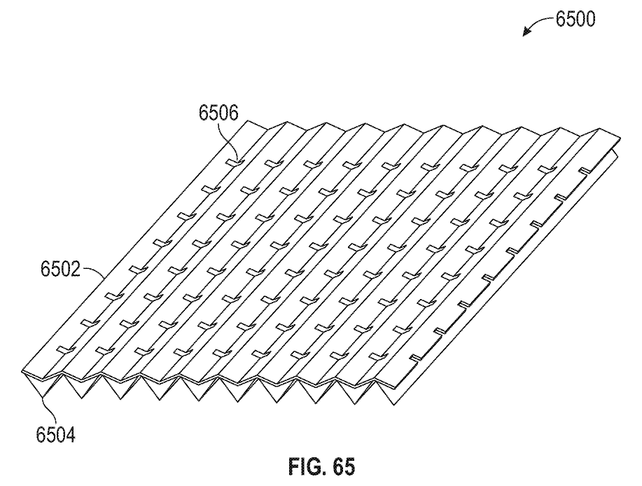

FIG. 65 shows a perspective view of a filter assembly 6500 according to a twenty-sixth embodiment. A first media layer 6502 features peaks and valleys, where each valley includes rectangle-shaped slit formations 6506. The peaks connect the first media layer 6502 to a second media layer 6504. In this embodiment, the rectangle-shaped slit formations 6506 extend with their major axes (e.g., along the long edge) perpendicular to the valleys, which differs from the twenty-fourth embodiment where they extend parallel to the valleys.

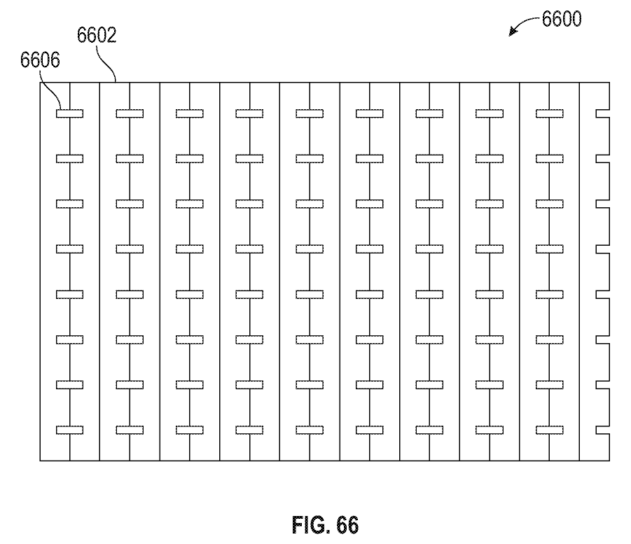

FIG. 66 shows a top view of the filter assembly 6600 according to the twenty-sixth embodiment, illustrating the arrangement of the rectangle-shaped slit formations 6606 within the valleys of the first media layer 6602, with the rectangles oriented perpendicular to the valleys.

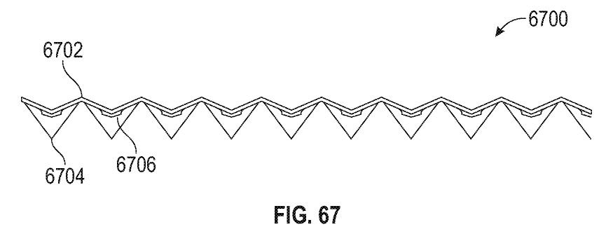

FIG. 67 shows an elevation view of the filter assembly 6700 according to the twenty-sixth embodiment, depicting the pleated configuration with the rectangle-shaped slit formations 6706 positioned in the valleys of the first media layer 6702 and the second media layer 6704.

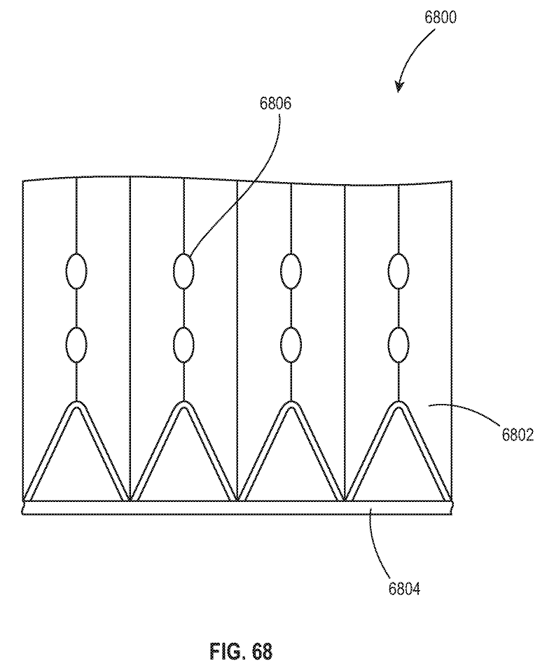

FIG. 68 shows a front perspective view of a filter assembly 6800 according to a twenty-seventh embodiment. In this embodiment, a first media layer 6802 includes peaks defining oval-shaped slit formations 6806 between the first media layer and a second media layer 6804. The first media layer 6802 functions as a pre-filter. As air passes into the pre-filter, particulate matter accumulates on the pre-filter surface, and the pre-filter becomes saturated over time. The flapped openings (i.e., the oval-shaped slit formations 6806) at the peaks enable air to travel through the pre-filter to the second media layer 6804. The second media layer 6804 may serve as a main filter, even when the pre-filter becomes saturated with particulates.

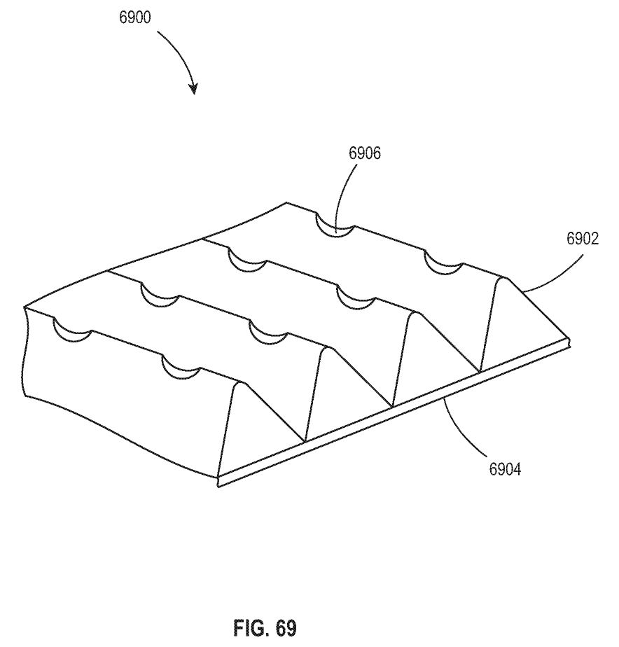

FIG. 69 shows a side perspective view of the filter assembly 6900 according to the twenty-seventh embodiment, further illustrating the positioning of the oval-shaped slit formations 6906 at the peaks of the first media layer 6902 above the second media layer 6904

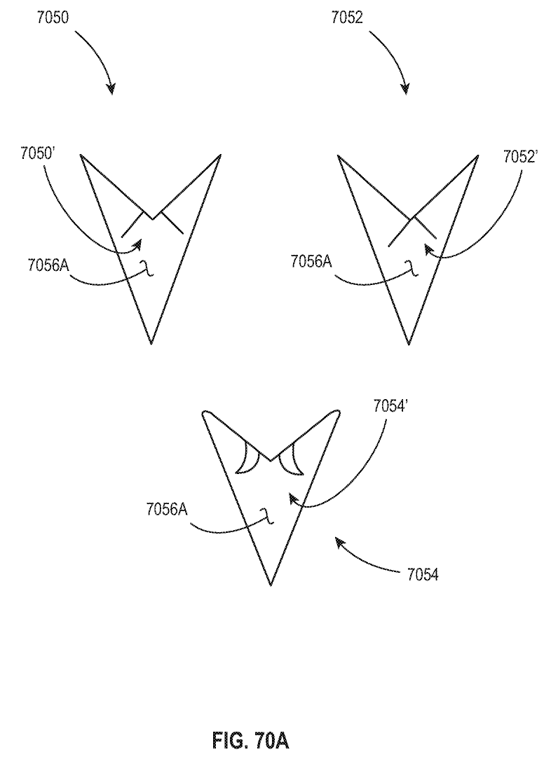

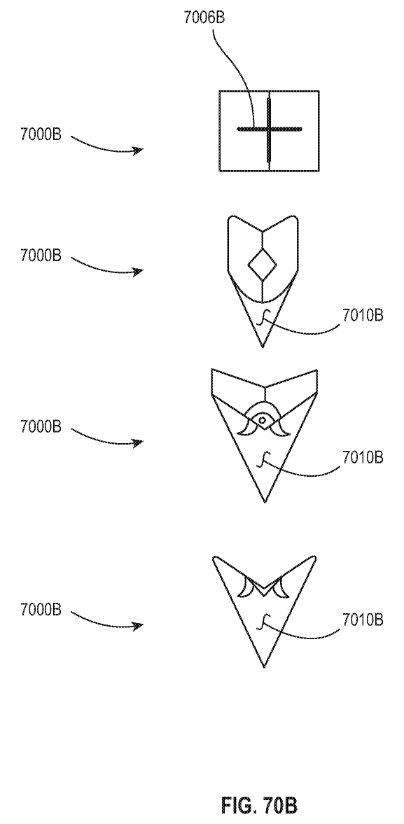

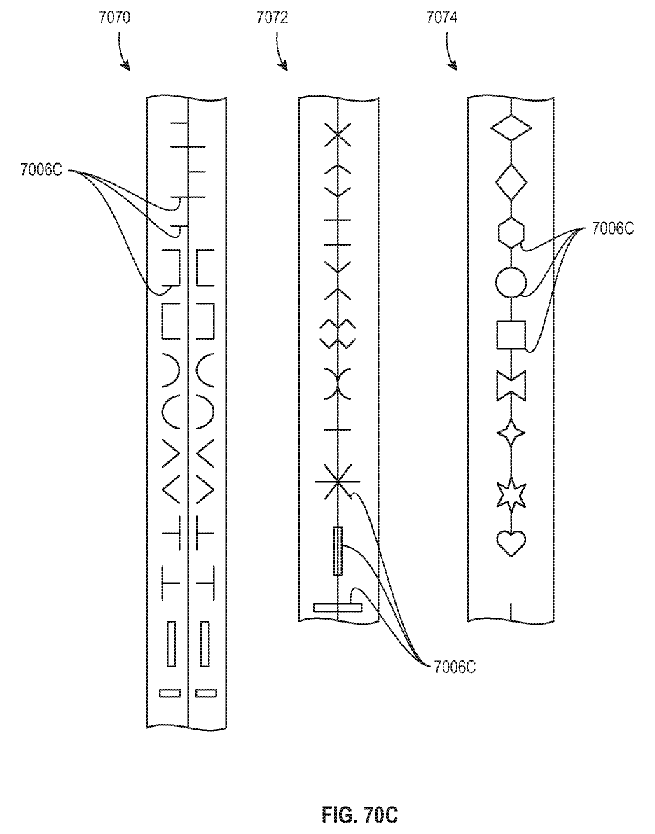

FIG. 70A shows three partial side views of different filter assemblies 7050, 7052, 7054, illustrating how the shape formed in a void 7056A, 7056B, 7056C of the first media layer is determined by the shape cut into the surface of the first media layer. Each filter assembly 7050, 7052, 7054 depicts a differently sloped flap configuration 7050', 7052', 7054', showing the relationship between the cut pattern and the resulting flap geometry.

FIG. 70B shows four differently angled views of a filter assembly 7000B having a plus-shaped slit formation 7006B. The first view (top of the page) is a top view, the second viewt (below the first view) is 30 degrees offset from the top view, the third view (below the second view) is 60 degrees offset from the top view, and the fourth view (bottom of the page) is a side view (i.e., 90 degrees offset from the top view). These views illustrate how the flaps appear in the void 7010B from different viewing angles.

FIG. 70C shows three partial top views of different filter assemblies 7070, 7072, 7074 having a plurality of slit formations 7006C of different shapes and geometries.

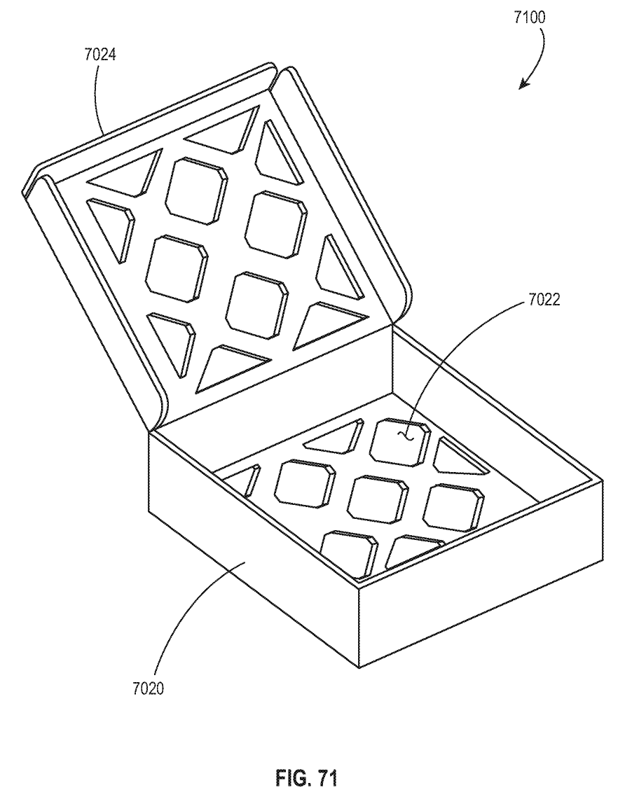

FIG. 71 shows a perspective view of a reusable frame assembly 7100 for use with an HVAC unit (e.g., a residential HVAC unit). The reusable frame assembly 7100 includes a frame body 7020 defining an interior space 7022 and a door 7024 hingedly connected to the frame body. Porous faces of the frame assembly 7100 (e.g., on the door 7024, on the frame body 7020) permit air to flow through the door, frame body, and interior space 7022 where a filter assembly is configured to be positioned. This permits a user to replace only the filter material within the interior space 7022 rather than replacing the entire frame assembly 7100, thereby reducing material costs and waste.

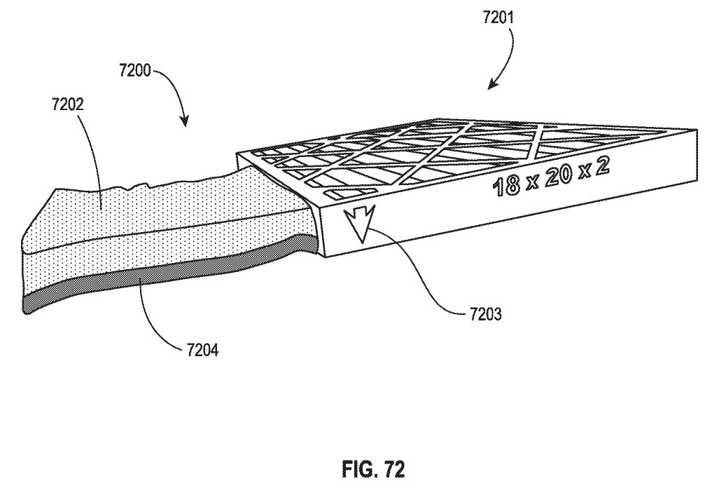

FIG. 72 shows a perspective view of a filter assembly 7200 according to a twenty-eighth embodiment. The filter assembly 7200 is positioned adjacent to a conventional residential filter 7201. A directional airflow indicator 7203 is provided on the surface of the conventional residential filter 7201, showing the intended direction for air to pass through the filter assembly 7200 (e.g., through a first media layer 7202 and second media layer 7204).

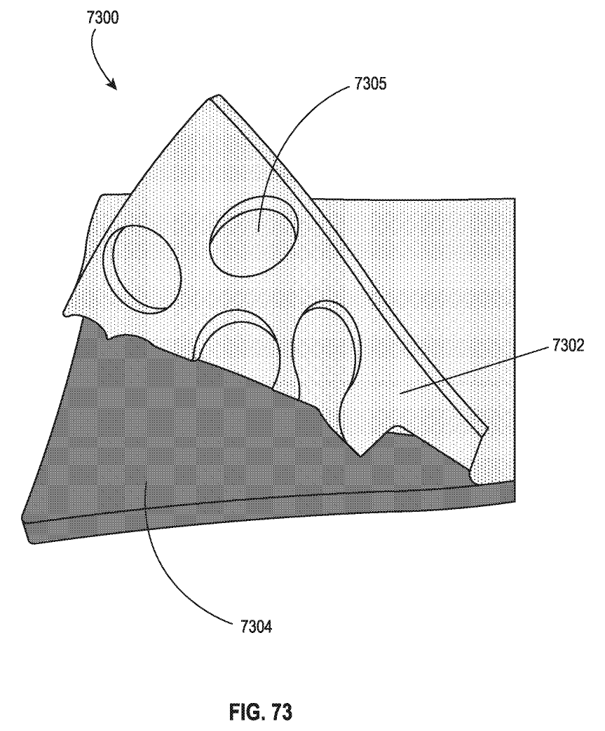

FIG. 73 shows a perspective view of the filter assembly 7300 according to the twenty-eighth embodiment, with the first media layer 7302 pulled away from the second media layer 7304 to reveal divots 7305 on an inner face of the first media layer. The divots 7305 are semi-spherical indentations in the first media layer 7302 (e.g., recesses) forming slit formations between the first media layer and the second media 7304 layer when the layers are positioned together.

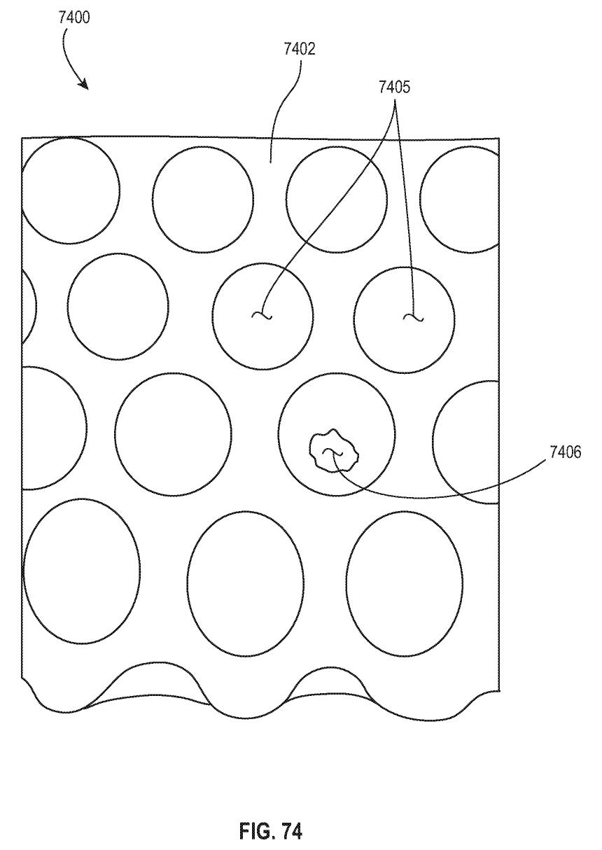

FIG. 74 shows a perspective view of the filter assembly 7400 according to the twenty-eighth embodiment, showing the filter assembly with a slit formation 7406 visible at the first media layer 7402. The divots 7405 form an array arranged in a honeycomb pattern for providing increased surface area for particulate capture.

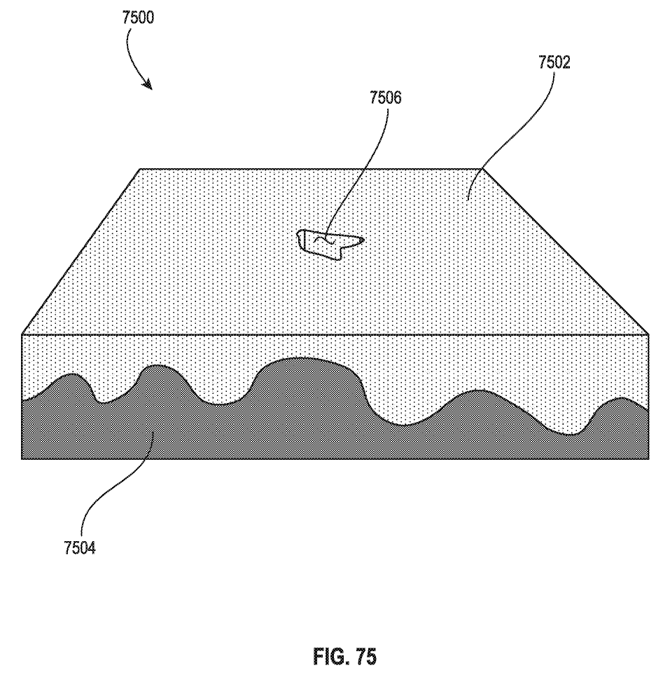

FIG. 75 shows a perspective view of the filter assembly 7500 according to the twenty-eighth embodiment, showing the filter assembly with the slit formation 7506 visible at an outer face of the first media layer 7502 above the second media layer 7504.

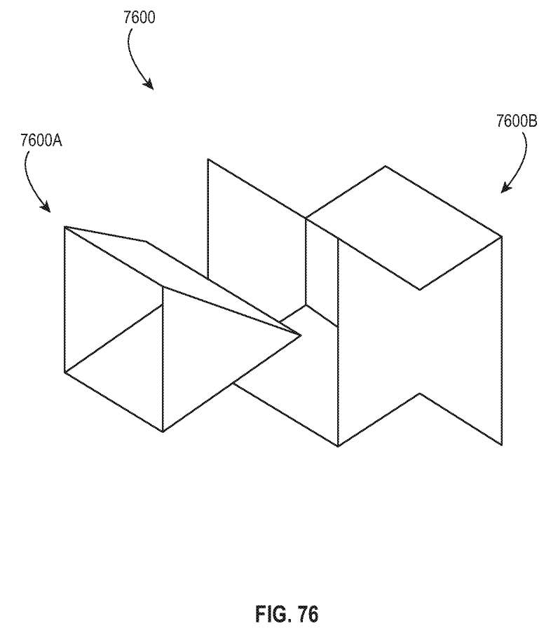

FIG. 76 shows a perspective view of a filter assembly 7600 in accordance with a twenty-ninth embodiment wherein a pre-filter 7600A is mated with a bowtie filter 7600B. The pre-filter 7600A has a triangular-prism geometry configured for mating with an intake side of the bowtie filter 7600B. In this configuration, the pre-filter 7600A can be replaced after becoming saturated with particulates, eliminating the need to replace the bowtie filter 7600B, which provides a more efficient and economical filtration solution.

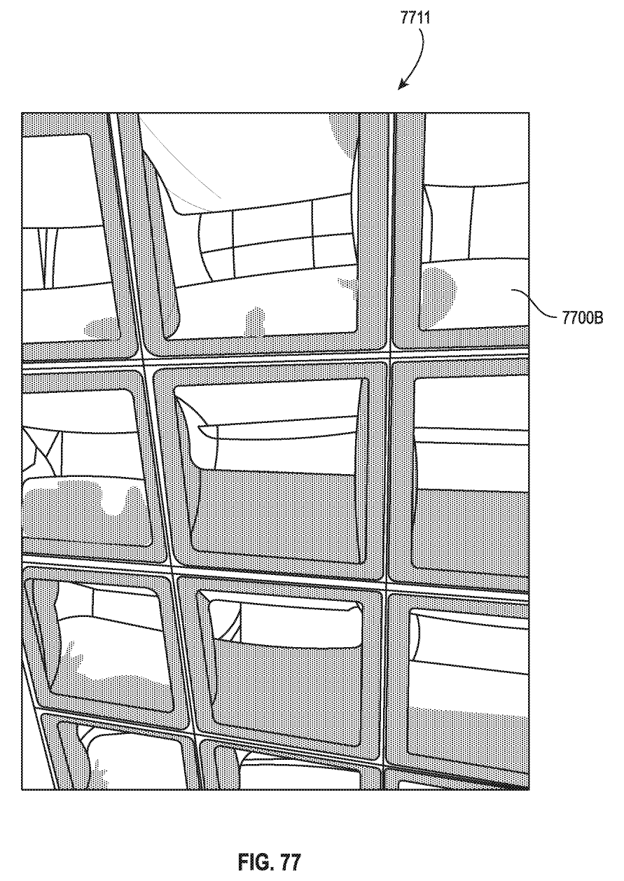

FIG. 77 shows a perspective view of a bowtie filter array 7711 without pre-filters 7700A installed. The bowtie filter array 7711 includes multiple bowtie filters 7700B arranged in a grid.

FIG. 78 shows a perspective view of the bowtie filter array 7811 with pre-filters 7800A installed. Each bowtie filter 7800B in the bowtie filter array 7811 is fitted with one corresponding pre-filter 7800A. The pre-filters 7800A include semi-spherical divots 7805 arranged in a honeycomb pattern at a surface of the pre-filter, providing increased surface area for particulate capture.

Through the incorporation of flaps, slit formations, and various geometric shapes in the media layers, these novel configurations of air filters offer increased surface area and multiple regions for debris accumulation. The inventive flap designs, ranging from rounded corners to semi-circular and multi-flap configurations, ensure optimized airflow control, thereby minimizing turbulence and maximizing particulate deposition. The various slit formation shapes, including X-shaped, star-shaped, plus-shaped, rhombus-shaped, oval-shaped, rectangle-shaped, hexagon-shaped, and other geometric slit formations, provide versatility in addressing different filtration requirements. Additionally, the pre-filter configurations (e.g., the twenty-seventh through twenty-ninth embodiments) demonstrate the adaptability of the disclosed filter assemblies for use with main filters, including bowtie filters (e.g., for use in paint-booth settings), as well as residential HVAC filters.

Moreover, the pleated filter designs leverage successive peaks and valleys, where various shaped slit formations, including X-shaped, star-shaped, plus-shaped, rhombus-shaped, oval-shaped, hexagon-shaped, rectangle-shaped, heart-shaped, and other geometric slit formations, further enhance the effectiveness of the filtration process. These unique structures provide additional surfaces for debris accumulation and ensure that air or fluid passes through multiple filtration layers, thereby improving the overall filtration performance. Embodiments of the present disclosure further enable extended product life by allowing filters (e.g., pre-filters) to be replaced independently when saturated.

The embodiments presented address existing limitations in conventional filters by providing improved control of airflow direction and enhanced particulate retention across different surfaces of the filter body. The structural enhancements described in these embodiments allow for improved durability, extended filter life, and greater efficiency in capturing particulate matter from air or liquid streams, which is particularly advantageous in environments where maintaining clean air quality is critical, such as spray booths and industrial filtration systems.

In view of the foregoing, the disclosed embodiments present a comprehensive and highly effective solution for improving filtration efficiency and airflow management in various industrial and commercial applications. The inventive designs provide the flexibility to adapt to different filter configurations and can be easily integrated into existing systems, ensuring broad applicability across multiple industries.

The above description does not provide specific details of the manufacture or design of the various components. Those of skill in the art are familiar with such details, and unless departures from those techniques are set out, techniques, known, related art or later developed designs and materials should be employed. Those in the art are capable of choosing suitable manufacturing and design details.

Further, the terminology used herein is for the purpose of describing particular embodiments only and is not intended to be limiting to the disclosure. It would be appreciated if several of the above-disclosed and other features and functions, or alternatives thereof, could be combined into other devices or applications.

What is claimed is:

1. A filter assembly comprising:
a filter body comprising filter media, the filter body having a rear face and side walls at least partially defining an internal cavity of the filter body; and
a front face of the filter body, the front face having one or more slit formations defining a plurality of flaps, wherein the plurality of flaps are configured to deflect inward into the internal cavity when subjected to airflow.

2. The filter assembly of claim 1, wherein the one or more slit formations comprise a cross-shaped slit formation.

3. The filter assembly of claim 1, wherein the one or more slit formations comprise a plus-shaped slit formation.

4. The filter assembly of claim 1, wherein the one or more slit formations comprise an X-shaped slit formation.

5. The filter assembly of claim 1, wherein at least one flap of the plurality of flaps has rounded corners.

6. The filter assembly of claim 1, wherein at least one flap of the plurality of flaps has a semi-circular edge toward the slit formation.

7. The filter assembly of claim 1, wherein the plurality of flaps are coplanar with the front face when not subjected to airflow.

8. A filter assembly comprising:
a first media layer configured with successive peaks and valleys;
a second media layer positioned adjacent to the first media layer, wherein the peaks of the first media layer are connected to the second media layer; and
a plurality of slit formations in the first media layer, each slit formation of the plurality of slit formations defining one or more flaps and passing through the first media layer.

9. The filter assembly of claim 8, wherein the plurality of slit formations comprise star-shaped slit formations positioned in the valleys of the first media layer.

10. The filter assembly of claim 8, wherein the plurality of slit formations comprise X-shaped slit formations positioned in the valleys of the first media layer.

11. The filter assembly of claim 8, wherein the plurality of slit formations comprise bowtie-shaped slit formations positioned in the valleys of the first media layer.

12. The filter assembly of claim 8, wherein the plurality of slit formations comprise hexagon-shaped slit formations positioned in the valleys of the first media layer.

13. The filter assembly of claim 8, wherein the plurality of slit formations comprise arrow-shaped slit formations positioned in the valleys of the first media layer.

14. The filter assembly of claim 8, wherein the plurality of slit formations comprise oval-shaped slit formations positioned at the peaks of the first media layer.

15. The filter assembly of claim 8, wherein open channels are formed between the peaks of the first media layer and the second media layer.

16. The filter assembly of claim 8, wherein the first media layer is configured as a pre-filter.

17. A filter assembly comprising:
a first media layer having a plurality of divots on an inner face thereof; and
a second media layer disposed adjacent to the inner face of the first media layer, such that the second media layer and the divots on the inner face of the first media layer define internal cavities of the filter assembly.

18. The filter assembly of claim 17, wherein the plurality of divots are arranged in a honeycomb pattern.

19. The filter assembly of claim 17, wherein the plurality of divots are semi-spherical.

20. The filter assembly of claim 17, wherein each divot of the plurality of divots includes an aperture passing through the first media layer.
